(19) United States
(12) Patent Application Publication
(10) Pub. No.: US 2024/0267391 A1
(43) Pub. Date: Aug. 8, 2024

(54) SYSTEMS AND METHODS FOR SECURITY EVENT ASSOCIATION RULE REFRESH

(71) Applicant: KnowBe4, Inc., Clearwater, FL (US)

(72) Inventors: Paras NIGAM, Bangalore (IN); Atish KATHPAL, Bangalore (IN); Sandeep BALAGOPAL, Kochi (IN)

(73) Assignee: KnowBe4, Inc., Clearwater, FL (US)

(21) Appl. No.: 18/432,659

(22) Filed: Feb. 5, 2024

Related U.S. Application Data
(60) Provisional application No. 63/491,631, filed on Mar. 22, 2023.

(30) Foreign Application Priority Data
Feb. 6, 2023 (IN) 202321007428

(51) Int. Cl. H04L 9/40

(52) U.S. Cl. CPC H04L 63/1416; H04L 63/1433; H04L 63/145

(57) ABSTRACT

Systems and methods are described for security event association rule refresh. One or more rules are executed against one or more user records in a user metadata store. The one or more rules may be configured to match a security event of one or more security events with a user of one or more users using user metadata. A count is determined of a number of times a rule of the one or more rules identifies a plurality of different users. It is further determined that one of the count exceeds a first threshold or a number of the plurality of different users exceeds a second threshold. Responsive to the determination, the rule via a user interface may display a prompt to take an action to one or more of review, remove or modify the rule by a system administrator.

### RELATED APPLICATIONS

This application claims the benefit of and priority to each of U.S. Provisional Application No. 63/491,631 titled “SYSTEMS AND METHODS FOR SECURITY EVENT ASSOCIATION RULE REFRESH” dated Mar. 22, 2023, and Indian Application No. 202321007428 titled “SYSTEMS AND METHODS FOR SECURITY EVENT ASSOCIATION RULE REFRESH” dated Feb. 6, 2023, of all which are incorporated herein in their entirety by reference for all purposes.

### FIELD OF DISCLOSURE

This disclosure relates to security awareness management. In particular, the present disclosure relates to systems and methods for security event association rule refresh.

### BACKGROUND OF THE DISCLOSURE

Cybersecurity incidents cost companies millions of dollars each year in actual costs and can cause customers to lose trust in an organization. The incidents of cybersecurity attacks and the costs of mitigating the damage are increasing every year. Many organizations use cybersecurity tools such as antivirus, anti-ransomware, anti-phishing, and other quarantine platforms to detect and intercept known cybersecurity attacks. However, new and unknown security threats involving social engineering may not be readily detectable by such cyber security tools, and the organizations may have to rely on their employees (referred to as users) to recognize such threats. To enable their users to stop or reduce the rate of cybersecurity incidents, the organizations may conduct security awareness training for their users. The organizations may conduct security awareness training through in-house cybersecurity teams or may use third parties which are experts in matters of cybersecurity. The security awareness training may include cybersecurity awareness training, for example, via simulated phishing attacks, computer-based training, and other training programs. Through security awareness training, organizations educate their users on how to detect and report suspected phishing communication, avoid clicking on malicious links, and use applications and websites safely.

### BRIEF SUMMARY OF THE DISCLOSURE

Systems and methods are provided for security event association rule refresh. In an example embodiment, a method is described for executing one or more rules against one or more user records in a user metadata store. In examples, the one or more rules may be configured to match a security event of one or more security events with a user of one or more users using user metadata. In some embodiments, the method includes identifying a count of a number of times a rule of the one or more rules identifies a plurality of different users. In some embodiments, the method includes determining that one of the count exceeds a first threshold or a number of the plurality of different users exceeds a second threshold. In some embodiments, the method includes displaying, responsive to the determination, the rule via a user interface to prompt an action to one or more of review, remove or modify the rule by a system administrator.

In some embodiments, the rule has a left-hand-side of the rule that comprises a security event identifier of one of the one or more security events and a right-hand-side of the rule that comprises the user metadata.

In some embodiments, the method further includes determining an ambiguity score for the rule of the one or more rules.

In some embodiments, the ambiguity score is based at least on the count.

In some embodiments, the method includes displaying, the ambiguity score with the rule.

In some embodiments, the method further includes determining that a plurality of rules results in an ambiguity of matching a user to the security event.

In some embodiments, the method further includes executing one or more rules of a same type from a combined rule list.

In some embodiments, the method further includes determining a ranked list of the one or more rules to one or more of review, remove or modify the one or more rules.

In some embodiments, the method further includes displaying the ranked list of the one or more rules to prompt the action to review, remove or modify by the system administrator.

In some embodiments, the method further includes executing a combined rule list against security event identifiers of security events in an unmapped security event store. In examples, the combined rule list is updated to exclude the identified rule.

In some embodiments, the method further includes triggering execution of the combined rule list against security event identifiers of security events in an unmapped security event store responsive to one of new user metadata or new user records in the user metadata store.

In another example embodiment, a system is described which is configured to execute one or more rules against one or more user records in a user metadata store. In examples, the one or more rules may be configured to match a security event of one or more security events with a user of one or more users using user metadata. In some embodiments, the system may be configured to identify a count of a number of times a rule of the one or more rules identifies a plurality of different users and determine that one of the count exceeds a first threshold or a number of the plurality of different users exceeds a second threshold. In some embodiments, the system may be configured to display, responsive to the determination, the rule via a user interface to prompt an action to one or more of review, remove or modify the rule by a system administrator.

In another embodiment, the system is configured to determine an ambiguity score for the rule of the one or more rules. The system may be further configured to display the ambiguity score with the rule. In embodiments, the system may be configured to determine that a plurality of rules results in an ambiguity of matching a user to the security event.

In some embodiments, the system is configured to execute one or more rules of a same type from a combined rule list. In embodiments the system is further configured to determine a ranked list of the one or more rules to one or more of review, remove or modify and further configured to display, by the one or more processors, the ranked list of the one or more rules to prompt the action to review, remove or modify by the system administrator.

In embodiments, the system is configured to execute a combined rule list against security event identifiers of security events in an unmapped security event store, the combined rule list updated to exclude the rule identified by the one or more processors. In some embodiments, the system is further configured to trigger execution of the combined rule list against security event identifiers of security events in an unmapped security event store responsive to one of new user metadata or new user records in the user metadata store.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIG. 1C and FIG. 1D are block diagrams depicting embodiments of computing devices useful in connection with the methods and systems described herein;

FIG. 2 depicts an implementation of some of a server and client architecture of a system for security event association rule refresh, according to some embodiments;

FIG. 3 illustrates a flow diagram of a user discovery and identification process, according to some embodiments;

FIG. 4 illustrates a flow diagram of an unsuccessful security event mapping by an association system, according to some embodiments;

FIG. 5 illustrates a flow diagram of an execution of an association system against a security event, according to some embodiments;

FIG. 6 illustrates an example trie structure for an exact rule of type “first name”, according to some embodiments;

FIG. 7 illustrates an example trie structure for a contains rule of type “first name contains”, according to some embodiments:

FIG. 8 illustrates an example updated trie structure for an exact rule of type “first name”, according to some embodiments;

FIG. 9 depicts a flowchart for security event association rule refresh, according to some embodiments; and

FIG. 10 depicts another flowchart for security event association rule refresh, according to some embodiments.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods that are useful for security event association rule refresh.

### A. Computing and Network Environment

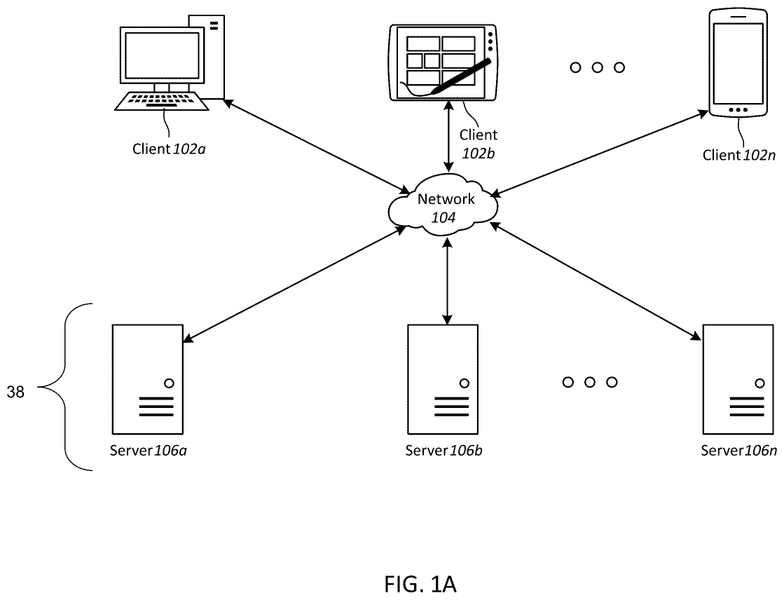

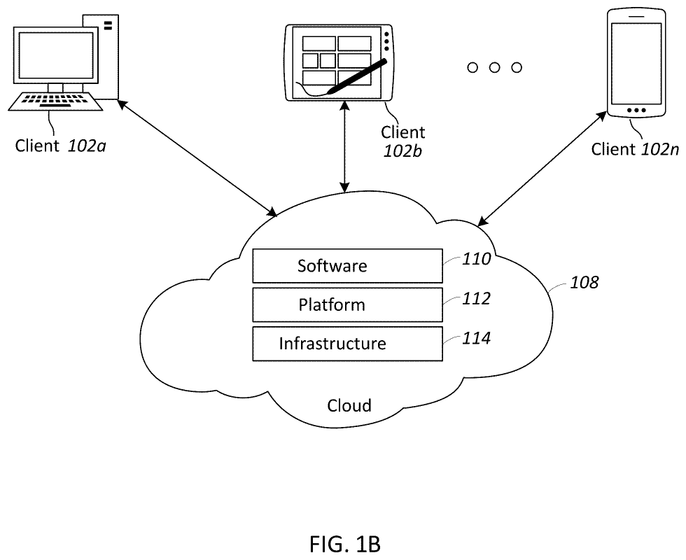

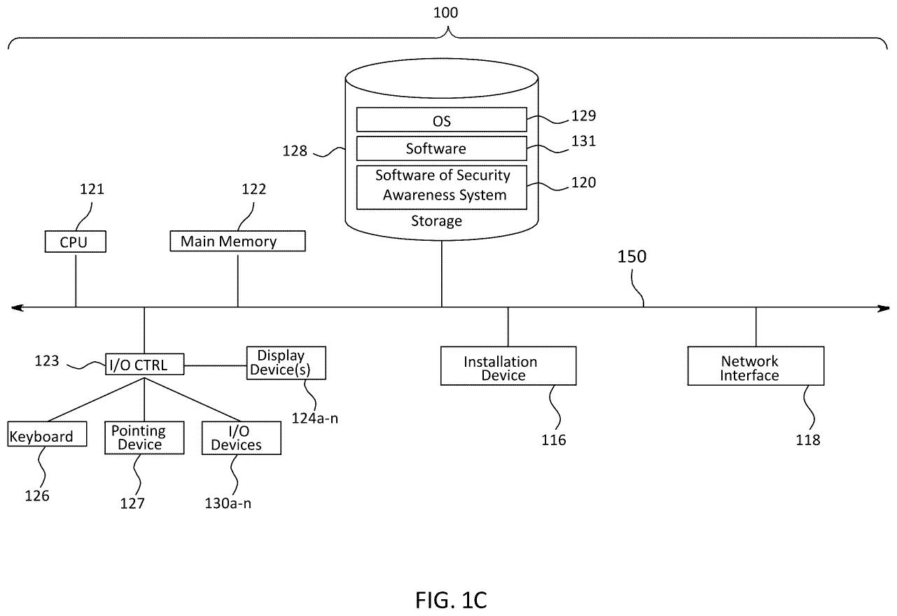

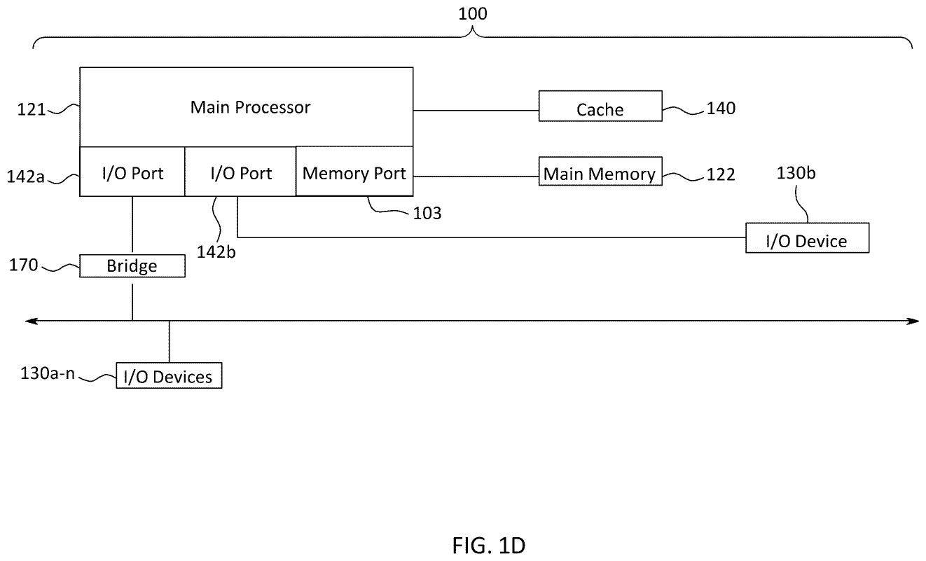

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP Internet protocol suite may include application layer, transport layer, Internet layer (including, e.g., IPv4 and IPv6), or the link layer. The network 104 may be a type of broadcast network, a telecommunications network, a data communication network, or a computer network.

In some embodiments, the system may include multiple, logically grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous—one or more of the servers 106 or machines 106 can operate according to one type of operating system platform (e.g., Windows, manufactured by Microsoft Corp. of Redmond, Washington), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, California; the Xen hypervisor, an open source product whose development is overseen by Citrix Systems, Inc. of Fort Lauderdale, Florida; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, California.

Management of the machine farm may be de-centralized. For example, one or more servers 106 may comprise components, subsystems, and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud-based delivery, e.g. Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers or virtualization resources from large pools, allowing the users to quickly scale up by accessing more resources as needed. Examples of IaaS include Amazon Web Services (AWS) provided by Amazon, Inc. of Seattle, Washington, Rackspace Cloud provided by Rackspace Inc. of San Antonio, Texas, Google Compute Engine provided by Google Inc. of Mountain View, California, or RightScale provided by RightScale, Inc. of Santa Barbara, California. PaaS providers may offer functionality provided by IaaS, including, e.g., storage, networking, servers, or virtualization, as well as additional resources, e.g., the operating system, middleware, or runtime resources. Examples of PaaS include Windows Azure provided by Microsoft Corporation of Redmond, Washington, Google App Engine provided by Google Inc., and Heroku provided by Heroku, Inc. of San Francisco California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, California, or Office365 provided by Microsoft Corporation. Examples of SaaS may also include storage providers, e.g., Dropbox provided by Dropbox Inc. of San Francisco, California, Microsoft OneDrive provided by Microsoft Corporation, Google Drive provided by Google Inc., or Apple iCloud provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. Google Chrome, Microsoft Internet Explorer, or Mozilla Firefox provided by Mozilla Foundation of Mountain View, California). Clients 102 may also access SaaS resources through smartphone or tablet applications, including e.g., Salesforce Sales Cloud, or Google Drive App. Clients 102 may also access SaaS resources through the client operating system, including e.g., Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIG. 1C and FIG. 1D depict block diagrams of a computing device 100 useful for practicing an embodiment of the client 102 or a server 106. As shown in FIG. 1C and FIG. 1D, each computing device 100 includes a central processing unit (CPU) 121, and a main memory unit 122. As shown in FIG. 1C, a computing device 100 may include a storage device 128, an installation device 116, a network interface 118, and I/O controller 123, display devices 124a-124n, a keyboard 126 and a pointing device 127, e.g., a mouse. The storage device 128 may include, without limitation, an Operating System (OS) 129, software 131, and software of a security awareness system 120. As shown in FIG. 1D, each computing device 100 may also include additional optional elements, e.g., a memory port 103, a bridge 170, one or more Input/Output (I/O) devices 130a-130n (generally referred to using reference numeral 130), and a cache memory 140 in communication with the central processing unit 121.

The central processing unit 121 is any logic circuitry that responds to, and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the central processing unit 121. Main memory unit 122 may be volatile and faster than storage 128 memory. Main memory units 122 may be Dynamic Random-Access Memory (DRAM) or any variants, including Static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile Random Access Memory (NVRAM), flash memory, non-volatile static RAM (nvSRAM), Ferroelectric RAM (FeRAM), Magnetoresistive RAM (MRAM), Phase-change RAM (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above-described memory chips, or any other available memory chips capable of operating as described herein. In the embodiment shown in FIG. 1C, the central processing unit 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the central processing unit 121 communicates directly with cache memory 140 via a secondary bus, sometimes referred to as a backside bus. In other embodiments, the central processing unit 121 communicates with cache memory 140 using the system bus 150. Cache memory 140 typically has a faster response time than main memory 122 and is typically provided by SRAM, BSRAM, or EDRAM. In the embodiment shown in FIG. 1D, the central processing unit 121 communicates with various I/O devices 130 via a local system bus 150. Various buses may be used to connect the central processing unit 121 to any of the I/O devices 130, including a PCI bus, a PCI-X bus, a PCI-Express bus, or a NuBus. For embodiments in which the I/O device is a video display 124, the central processing unit 121 may use an Advanced Graphic Port (AGP) to communicate with the display 124 or the I/O controller 123 for the display 124. FIG. 1D depicts an embodiment of a computer 100 in which the central processing unit 121 communicates directly with I/O device 130b or other central processing units 121′ via HYPERTRANSPORT, RAPIDIO, or INFINIBAND communications technology. FIG. 1D also depicts an embodiment in which local busses and direct communication are mixed: the central processing unit 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iphone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen displays, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices 130a-130n may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation device 116 for the computing device 100. In still other embodiments, the computing device 100 may provide USB connections (not shown) to receive handheld USB storage devices. In further embodiments, a I/O device 130 may be a bridge between the system bus 150 and an external communication bus, e.g., a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to VO controller 123. Display devices may include, e.g., liquid crystal displays (LCD), thin film transistor LCD (TFT-LCD), blue phase LCD, electronic papers (e-ink) displays, flexile displays, light emitting diode (LED) displays, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One of ordinary skill in the art will recognize and appreciate the various ways and embodiments that a computing device 100 may be configured to have multiple display devices 124a-124n.

Referring again to FIG. 1C, the computing device 100 may comprise storage device 128 (e.g., one or more hard disk drives or redundant arrays of independent disks) for storing an operating system or other related software, and for storing application software programs such as any program related to the software of security awareness system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices 128 may include multiple volatile and non-volatile memories, including, e.g., solid state hybrid drives that combine hard disks with solid state cache. Some storage devices 128 may be non-volatile, mutable, or read-only. Some storage devices 128 may be internal and connect to the computing device 100 via a bus 150. Some storage devices 128 may be external and connect to the computing device 100 via a I/O device 130 that provides an external bus. Some storage devices 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage devices 128 may also be used as an installation device 116 and may be suitable for installing software and programs. Additionally, the operating system and the software can be run from a bootable medium, for example, a bootable CD, e.g., KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMAX, and direct asynchronous connections). In one embodiment, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem, or any other device suitable for interfacing the computing device 100 to any type of network capable of communication and performing the operations described herein.

A computing device 100 of the sort depicted in FIG. 1B and FIG. 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Washington; MAC OS and iOS, manufactured by Apple, Inc.; and Linux, a freely-available operating system, e.g., Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the iPod Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple lossless audio file formats and. mov, .m4v, and .mp4 MPEG-4 (H.264/MPEG-4 AVC) video file formats.

In some embodiments, the computing device 100 is a tablet e.g., the iPAD line of devices by Apple; GALAXY TAB family of devices by Samsung; or KINDLE FIRE, by Amazon.com, Inc. of Seattle, Washington. In other embodiments, the computing device 100 is an eBook reader, e.g. the KINDLE family of devices by Amazon.com, or NOOK family of devices by Barnes & Noble, Inc. of New York City, New York.

In some embodiments, the communications device 102 includes a combination of devices, e.g., a smartphone combined with a digital audio player or portable media player. For example, one of these embodiments is a smartphone, e.g., the iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g., a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in network 104 is monitored as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Security Event Association Rule Refresh

The following describes systems and methods for security event association rule refresh.

Hackers may exploit users of an organization to gain access to assets of the organization. To prevent such instances of exploitation, the organization may provide security training to the users to prevent cybersecurity attacks. However, in certain scenarios, generic security training may not be effective due to the lack of context and timeliness of the security training. In examples, effective training is real-time, personalized for each user, relevant to the users' role in the organization, and is based not only on the current risk but also on anticipated future threats. These requirements for effective training and appropriate security actions may depend on the accurate association of security events with the users. A security event may refer to a cybersecurity attack or a cybersecurity threat that involves or is attributable to a user. Examples of security events include, but are not limited to, phishing attacks, connections to insecure devices or websites, downloading from insecure or malicious websites, providing user credentials to insecure or malicious websites, and attempting to download or install software. A security event may include one or more security event identifiers of different types. A security event identifier may represent information associated with the security event. In examples, the information may be of various kinds. In an example, if a security event is an attempted access to an unauthorized website, then a security event identifier may be an Internet Protocol (IP) address of a device used to attempt the access. Further, a security event identifier type may be classification of the kinds of information associated with a security event. Examples of the security event identifier type include username, IP address, media access control (MAC) address, and hostname.

In scenarios where the association of a security event with a user is robust, the user may be provided security training relevant to the security event. Likewise, relevant security trainings pertaining to the security events may be provided to all users of the organization. This may lead to greater security awareness, informed users, and a safer organization. In examples, a reliable history of security incidents, user and training may be built.

A user of an organization typically uses many information technology (IT) devices or systems in the course of his or her work in the organization. In examples, access to those IT devices or systems typically requires the user to establish or create credentials. Examples of credentials include a username and a password. Different IT devices or systems often have different credentials. Additionally, different IT devices or systems may rely on different IT resources. For example, an IT resource used by a user of one IT device or system may be different from an IT resource used by the same user on another IT device or system.

In examples, a security awareness system may process security events received from security endpoints and other IT systems and may attempt to map the security events to a unique user of the organization. The mapping process may leverage information related to the security events and information related to the users and the devices involved (collectively referred to as user metadata).

A rule is an expression which maps a security event identifier to a user using user metadata. In examples, a rule may have a left-hand-side (LHS) of the rule that includes a security event identifier of a security event and a right-hand-side (RHS) of the rule that includes user metadata in user records, of the same type. In an example, the RHS of the rule is executed against metadata of user records until one or more users are matched (which indicates that the rule maps the security event to a user). In an example, the RHS of all rules (rules of each type) are executed against all user metadata of all user records (of the corresponding type) and any user matches which are found are recorded. After the completion of the execution of the rules of the rule type, the recorded user matches are analyzed to see if they are identical (an unambiguous mapping was found) or if no users were matched or if two or more users were matched (which indicates that the rules of the rule type cannot unambiguously map the security event to a user). A rule type may be aligned with a security event identifier type. When a security event is detected, the different types of security event identifiers that are present determine the type of rule that is executed.

Rules may be defined by a system administrator of the organization, by a security system in the organization, or by the security awareness system. Rules may be used to associate security events with users of the organization. In examples, each rule may have a rule type which may be aligned to a security event identifier type. When a security event is detected, different types of security event identifiers that may be present determines the types of rules which are to be executed.

In some scenarios, organizational information may change over time which may result in changes to user metadata. In examples, new users may be added to an Active Directory of the organization, devices may be reassigned to new users, users may move physical locations and their devices may be reassigned with IP addresses that were previously assigned to other users. A system administrator may also create new rules. In examples, changes in user metadata may impact rules used to map security events to users. For example, a rule which previously mapped a security event to a single user may later map a security event to two or more different users, which is undesirable. Since the rule results in ambiguity, the rule may now be considered ambiguous. In some examples, different rules may map a security event to two or more different users, which is undesirable. Further, in some examples, a rule may not map a security event to any user. As a result of the rule not being able to map the security event to any user, an opportunity to train a user is lost.

As described above, one or more new rules may be created. In examples, the one or more new rules and one or more existing rules may return match results to different users when applied to security event identifiers of some security events, when previously only a single user would be returned. A match result may be an incident of LHS of a rule matching RHS of the rule. In some instances, the presence of a small number of rules with a high propensity to render ambiguous results may hinder the ability of other rules to associate a user with a security event. As a result, the number or proportion of security events that can be unambiguously mapped to a single user may decrease. When several rules have undesirable outcomes due for example to organizational information being changed or new rules being created, the probability of unambiguously mapping a security event to a user may decrease. In some scenarios, it may not be possible to unambiguously map a majority of security events to users. When rules cannot unambiguously map a security event to a user, the opportunity to provide relevant training to the user or perform other security actions associated with the security event may be lost.

The present disclosure describes systems and methods for security event association rule refresh. According to aspects of the present disclosure, rules which result in ambiguous match results between security events and users, either individually or in combination with other rules, may be reviewed, removed, or modified.

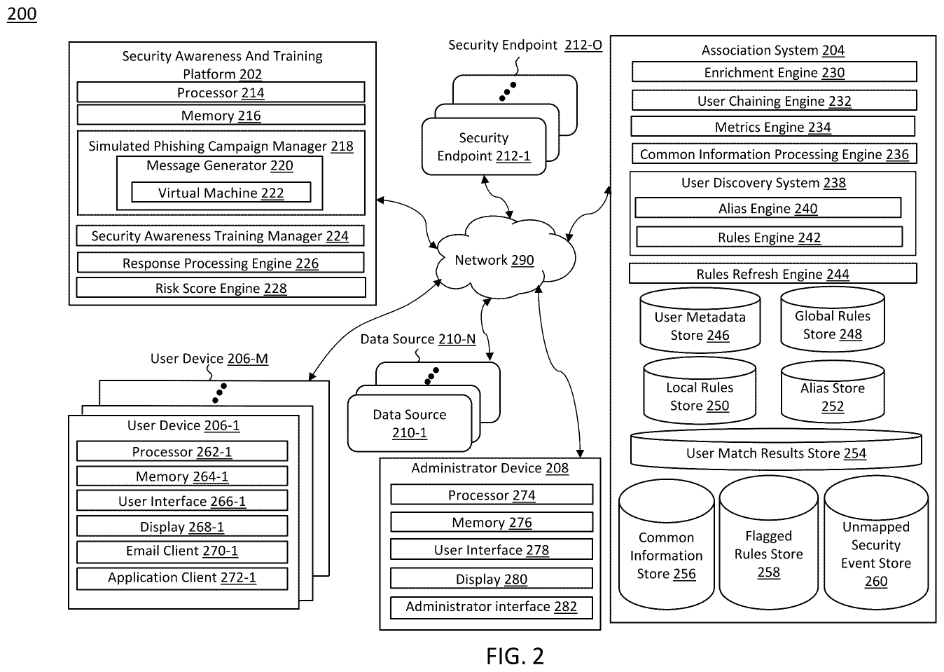

Referring to FIG. 2, in a general overview, FIG. 2 depicts some of the server architecture of an implementation of a system 200 for security event association rule refresh, according to some embodiments. System 200 may include security awareness and training platform 202, association system 204, user device(s) 206(1-M), administrator device 208, data sources 210-(1-N), security endpoints 212-(1-0), and network 290 enabling communication between the system components for information exchange. Network 290 may be an example or instance of network 104, details of which are provided with reference to FIG. 1A and its accompanying description.

According to some embodiments, security awareness and training platform 202 and association system 204 may be implemented in a variety of computing systems, such as a mainframe computer, a server, a network server, a laptop computer, a desktop computer, a notebook, a workstation, and the like. In an implementation, security awareness and training platform 202 and association system 204 may be implemented in a server, such as server 106 shown in FIG. 1A. In some implementations, security awareness and training platform 202 and association system 204 may be implemented by a device, such as computing device 100 shown in FIG. 1C and FIG. 1D. In some embodiments, each of security awareness and training platform 202 and association system 204 may be implemented as a part of a cluster of servers. In some embodiments, each of security awareness and training platform 202 and association system 204 may be implemented across a plurality of servers, thereby, tasks performed by security awareness and training platform 202 and association system 204 may be performed by the plurality of servers. These tasks may be allocated among the cluster of servers by an application, a service, a daemon, a routine, or other executable logic for task allocation. The term “application” as used herein may refer to one or more applications, services, routines, or other executable logic or instructions. Each of security awareness and training platform 202 and association system 204 may comprise a program, service, task, script, library, application, or any type and form of executable instructions or code executable on one or more processors. Security awareness and training platform 202 and association system 204 may be combined into one or more modules, applications, programs, services, tasks, scripts, libraries, applications, or executable code.

In one or more embodiments, security awareness and training platform 202 may be a system that manages items relating to cybersecurity awareness for an organization. The organization may be an entity that is subscribed to or that makes use of services provided by security awareness and training platform 202. In examples, the organization may be expanded to include all users within the organization, vendors to the organization, or partners of the organization. According to an implementation, security awareness and training platform 202 may be deployed by the organization to monitor and educate users thereby reducing cybersecurity threats to the organization. In an implementation, security awareness and training platform 202 may educate users within the organization by performing simulated phishing campaigns on the users. In an example, a user of the organization may include an individual that is tested and trained by security awareness and training platform 202. In examples, a user of the organization may include an individual that can or does receive electronic messages. For example, the user may be an employee of the organization, a partner of the organization, a member of a group, an individual who acts in any capacity of security awareness and training platform 202, such as a system administrator, or anyone associated with the organization. The system administrator may be an individual or team managing organizational cybersecurity aspects on behalf of an organization. The system administrator may oversee and manage security awareness and training platform 202 to ensure cybersecurity awareness training goals of the organization are met. For example, the system administrator may oversee Information Technology (IT) systems of the organization for configuration of system personal information use, managing simulated phishing campaigns, identification, and classification of threats within reported emails, and any other element within security awareness and training platform 202. Examples of system administrator include an IT department, a security team, a manager, or an Incident Response (IR) team. In some implementations, security awareness and training platform 202 may be owned or managed or otherwise associated with an organization or any entity authorized thereof. A simulated phishing attack is a technique of testing a user to see whether the user is likely to recognize a true malicious phishing attack and act appropriately upon receiving the malicious phishing attack. The simulated phishing attack may include links, attachments, macros, or any other simulated phishing threat (also referred to as an exploit) that resembles a real phishing threat. In response to user interaction with the simulated phishing attack, for example, if the user clicks on a link (i.e., a simulated phishing link), the user may be provided with security awareness training. In an example, security awareness and training platform 202 may be a Computer Based Security Awareness Training (CBSAT) system that performs security services such as performing simulated phishing attacks on a user or a set of users of the organization as a part of security awareness training.

According to some embodiments, security awareness and training platform 202 may include processor 214 and memory 216. For example, processor 214 and memory 216 of security awareness and training platform 202 may be CPU 121 and main memory 122, respectively as shown in FIG. 1C and FIG. 1D. Further, security awareness and training platform 202 may include simulated phishing campaign manager 218. Simulated phishing campaign manager 218 may include various functionalities that may be associated with cybersecurity awareness training. In an implementation, simulated phishing campaign manager 218 may be an application or a program that manages various aspects of a simulated phishing attack, for example, tailoring and/or executing a simulated phishing attack. A simulated phishing attack may test the readiness of a user to manage phishing attacks such that malicious actions are prevented. For instance, simulated phishing campaign manager 218 may monitor and control timing of various aspects of a simulated phishing attack including processing requests for access to attack results and performing other tasks related to the management of a simulated phishing attack.

In some embodiments, simulated phishing campaign manager 218 may include message generator 220 having virtual machine 222. Message generator 220 may be an application, service, daemon, routine, or other executable logic for generating messages. The messages generated by message generator 220 may be of any appropriate format. For example, the messages may be email messages, text messages, short message service (SMS) messages, instant messaging (IM) messages used by messaging applications such as, e.g., WhatsApp™, or any other type of message. In examples, a message type to be used in a particular simulated phishing communication may be determined by, for example, simulated phishing campaign manager 218. Message generator 220 generates messages in any appropriate manner, e.g., by running an instance of an application that generates the desired message type, such as running, e.g., a Gmail® application, Microsoft Outlook™, WhatsApp™, a text messaging application, or any other appropriate application. Message generator 220 may generate messages by running a messaging application on virtual machine 222 or in any other appropriate environment. Message generator 220 generates the messages to be in a format consistent with specific messaging platforms, for example, Outlook 365™, Outlook® Web Access (OWA), Webmail™, iOS®, Gmail®, and such formats.

In an implementation, message generator 220 may be configured to generate simulated phishing communications using a simulated phishing template. A simulated phishing template is a framework used to create simulated phishing communications. In some examples, a simulated phishing template may specify the layout and content of one or more simulated phishing communications. In an example, the simulated phishing template may include fixed content including text and images. In some examples, a simulated phishing template may be designed according to theme or subject matter. The simulated phishing template may be configurable by a system administrator. For example, the system administrator may be able to add dynamic content to the simulated phishing template, such as a field that will populate with a recipient's name and email address when message generator 220 prepares simulated phishing communications based on the simulated phishing template for sending to a user. In an example, the system administrator may be able to select one or more exploits to include in the simulated phishing template, for example, one or more simulated malicious URLs, one or more simulated macros, and/or one or more simulated attachments. An exploit is an interactable phishing tool in simulated phishing communications that can be clicked on or otherwise interacted with by a user. A simulated phishing template customized by the system administrator can be used for multiple different users in the organization over a period of time or for different campaigns. In some examples, a system administrator may select a simulated phishing template from a pool of available simulated phishing templates and may send such a “stock” template to users unchanged. The simulated phishing template may be designed to resemble a known real phishing attack such that simulated phishing communications based on the simulated phishing template may be used to train users to recognize these real attacks.

In some embodiments, security awareness and training platform 202 may include security awareness training manager 224, response processing engine 226, and risk score engine 228. In an implementation, security awareness training manager 224 may be an application or a program that includes various functionalities that may be associated with providing security awareness training to users of the organization. In an example, training material may be provided or presented to the users as a part of training. In examples, security awareness training manager 224 provides or presents the training material when the user interacts with a simulated phishing communication. In some examples, security awareness training manager 224 provides or presents training material during usual training sessions. The training material may include material to educate users of the risk of interacting with suspicious messages (communications) and train users on precautions in dealing with unknown, untrusted, and suspicious messages.

According to an implementation, security awareness training manager 224 may provide training to the users via landing pages. In an example, a landing page may be a web page element which enables provisioning of training materials. In some examples, the landing page may be a pop-up message. A pop-up message shall be understood to refer to the appearance of graphical or textual content on a display. In examples, the training material or the learning material may be presented on the display as part of, or bounded within, a “window” or a user interface element or a dialogue box. Other known examples and implementations of training materials are contemplated herein.

In an implementation, response processing engine 226 may be an application or a program that is configured to receive and process user interaction with the simulated phishing attack. The user interaction may include a user clicking a simulated phishing link, downloading attachments such as a file or a macro, opening the message, replying to the message, clicking on the message, deleting the message without reporting, reporting the message, or not taking any action on the message. If the user has clicked a simulated phishing link, downloaded attachments such as a file or a macro, deleted the message without reporting, opened the message to read the contents, replied to the message, clicked on the message, deleted the message or did not take any action on the message, response processing engine 226 may provide the user with corresponding security awareness training based on aforementioned type of the user interaction with the simulated phishing message. For user interaction that involves the user reporting the message, response processing engine 226 may share a congratulatory message and update a user maturity level of the user in the organization.

In an implementation, risk score engine 228 may be an application or a program for determining and maintaining risk scores for users in an organization. A risk score of a user may be a representation of vulnerability of the user to a malicious attack or the likelihood that a user may engage in an action associated with a security risk. In an implementation, risk score engine 228 may maintain more than one risk score for each user. Each such risk score may represent one or more aspects of vulnerability of the user to a specific cyberattack. In an implementation, risk score engine 228 may calculate risk scores for a group of users, for the organization, for an industry (for example, an industry to which the organization belongs), a geography, and so on. In an example, a risk score of the user may be modified based on the user's responses to simulated phishing communications, completion of training by the user, a current position of the user in the organization, a size of a network of the user, an amount of time the user has held the current position in the organization, a new position of the user in the organization if the position changes, for example due to a promotion or change in department and/or any other attribute that can be associated with the user.

In an implementation, response processing engine 226 and risk score engine 228 amongst other units, may include routines, programs, objects, components, data structures, etc., which may perform particular tasks or implement particular abstract data types. In examples, response processing engine 226 and risk score engine 228 may also be implemented as signal processor(s), state machine(s), logic circuitries, and/or any other device or component that manipulate signals based on operational instructions.

In some embodiments, response processing engine 226 and risk score engine 228 may be implemented in hardware, instructions executed by a processing module, or by a combination thereof. In examples, the processing module may be central processing unit 121, as shown in FIG. 1D. The processing module may comprise a computer, a processor, a state machine, a logic array, or any other suitable devices capable of processing instructions. The processing module may be a general-purpose processor which executes instructions to cause the general-purpose processor to perform the required tasks or the processing module may be dedicated to performing the required functions. In some embodiments, response processing engine 226 and risk score engine 228 may be machine-readable instructions which, when executed by a processor/processing module, perform intended functionalities of response processing engine 226 and risk score engine 228. The machine-readable instructions may be stored on an electronic memory device, hard disk, optical disk, or other machine-readable storage medium or non-transitory medium. In an implementation, the machine-readable instructions may also be downloaded to the storage medium via a network connection.

Referring again to FIG. 2, in some embodiments, association system 204 may include enrichment engine 230, user chaining engine 232, metrics engine 234, common information processing engine 236, and user discovery system 238. In some embodiments, user discovery system 238 may include alias engine 240 and rules engine 242. In an implementation, association system 204 also includes rules refresh engine 244.

In an implementation, enrichment engine 230, user chaining engine 232, metrics engine 234, common information processing engine 236, user discovery system 238, alias engine 240, rules engine 242, and rules refresh engine 244 amongst other units, may include routines, programs, objects, components, data structures, etc., which may perform particular tasks or implement particular abstract data types. In examples, enrichment engine 230, user chaining engine 232, metrics engine 234, common information processing engine 236, user discovery system 238, alias engine 240, rules engine 242, and rules refresh engine 244 may also be implemented as signal processor(s), state machine(s), logic circuitries, and/or any other device or component that manipulate signals based on operational instructions.

In some embodiments, enrichment engine 230, user chaining engine 232, metrics engine 234, common information processing engine 236, user discovery system 238, alias engine 240, rules engine 242, and rules refresh engine 244 may be implemented in hardware, instructions executed by a processing module, or by a combination thereof. In examples, the processing module may be central processing unit 121, as shown in FIG. 1D. The processing module may comprise a computer, a processor, a state machine, a logic array, or any other suitable devices capable of processing instructions. The processing module may be a general-purpose processor which executes instructions to cause the general-purpose processor to perform the required tasks or the processing module may be dedicated to performing the required functions. In some embodiments, enrichment engine 230, user chaining engine 232, metrics engine 234, common information processing engine 236, user discovery system 238, alias engine 240, rules engine 242, and rules refresh engine 244 may be machine-readable instructions which, when executed by a processor/processing module, perform intended functionalities of enrichment engine 230, user chaining engine 232, metrics engine 234, common information processing engine 236, user discovery system 238, alias engine 240, rules engine 242, and rules refresh engine 244. The machine-readable instructions may be stored on an electronic memory device, hard disk, optical disk, or other machine-readable storage medium or non-transitory medium. In an implementation, the machine-readable instructions may also be downloaded to the storage medium via a network connection. Although, association system 204 is shown external to security awareness and training platform 202, in some embodiments, association system 204 may be implemented within security awareness and training platform 202.

Further, in some embodiments, association system 204 may include user metadata store 246, global rules store 248, local rules store 250, alias store 252, user match results store 254, common information store 256, flagged rules store 258, and unmapped security event store 260.

In an implementation, user metadata store 246 may store information and metadata associated with users of an organization. In examples, metadata (interchangeably referred to as user metadata) may be available from several different sources or provided by different mechanisms. For example, Active Directory integration or the uploading of user information in an Excel format by the organization may provide metadata for users. In some examples, metadata may also be associated with IT devices which are associated with the users. Examples of user metadata include usernames, hostnames, IP addresses, handles and device IDs. User attributes, user relationships, and other information may be used by a process to align metadata to a user. Examples of user attributes include addresses, roles, department, or organizational units. Examples of user relationships include manager, subordinate, human resource partner, dotted reporting manager, peer, corporate buddy, etc.

In one or more embodiments, user metadata store 246 may comprise a user attribute lake. The user attribute lake may include user data records (where there is one user data record for each user) which include all known data about the users. For example, user attributes may be used to assign a device MAC address to a user, or to assign an IP address to a user. The assignment of metadata to a user may be associated with a confidence score which represents how confident the metadata association to the user is, based on user attributes and other user information about the user in the organization. In an example, the confidence score may be a value from 1 to 10, where 10 represents the highest level of confidence and 1 represents the lowest level of confidence. For example, an identifying metadata of a device may be a hostname, a MAC address, a domain name, an IP address, an international mobile equipment identity (IMEI), an international mobile subscriber identity (IMSI), a phone number, a device ID, or any other identifying attributes. If the device is assigned to only one user of the organization, then the metadata of the device may be unambiguously associated with the user. For example, a laptop with the hostname “proxy_server_A”, MAC address “12:34:56:a2:b4:c6”, and IP address “100.123.1.1” may be determined to be associated with the user “userA” because the user “user A” is assigned the laptop with MAC address “12:34:56:a2:b4:c6”.

In examples, metadata from different sources, if unambiguously associated with a user, can be combined together into a user record which is stored in user metadata store 246. For example, the user record for the user “userA”, in addition to the metadata related to the laptop that is assigned to the user “userA”, may include the email address “userA@email.com” which is extracted from the Active Directory of the organization.

In an implementation, global rules store 248 may store global rules. In examples, the global rules may be created by association system 204. In an implementation, local rules store 250 may store local rules. In examples, the local rules may be created by a system administrator. In examples, the aggregation of the local rules and the global rules may be referred to as a combined rules list. All global rules and all local rules are subsequently referred to as rules. Each rule has a left-hand-side (LHS), a rule type, and a right-hand-side (RHS). The LHS is a security event identifier and the RHS is user metadata. The rules are explained in greater detail later in the disclosure.

In an implementation, alias store 252 may store user aliases. In examples, the user aliases may be created by association system 204. User aliases may be used to associate security events with users of an organization, such that the users can be coached, trained, or have their risk scores modified based on the security events. In an example, a user alias may be used to determine a user of the organization with which a security event may be associated. A user alias directly maps a security event identifier with a user of an organization. A user may have multiple user aliases. In an example, user aliases for a user “userA” may include a user alias “hostname=userAhost” and a user alias “email=userAalternative@email.com”. In examples, a LHS of a user alias may be referred to as an alias identifier. In examples, alias identifiers may be classified by type, where the types of alias identifiers are aligned with the types of security event identifiers and the types of rules. In an example, “John Smith” may be a user of an organization. The user “John Smith” may have an email address “jsmith@organization.org”, a slack handle “JSEngineer”, and a corporate intranet login “JohnSmith”. Each of “jsmith”, “JSEngineer” and “JohnSmith” may be considered as alias identifiers of different user aliases for the user “John Smith”. In examples, a user alias may be assigned to a user directly (for example, by a system administrator or by the user himself or herself) using a user interface (UI). In an example, the system administrator may approve a user's selected user alias via a UI.

In an implementation, user match results store 254 may store one or more match results. A match result is an incident of the LHS of a rule matching the RHS of the rule. A match result may be considered together with other match results of a same security event to determine whether or not a user alias should be created or removed. In an implementation, common information store 256 may store security events after conversion to a common format. In an implementation, flagged rules store 258 may store one or more flagged rules. In examples, a rule may be flagged if the rule results in an ambiguity. In an implementation, unmapped security event store 260 may store unmapped security events (i.e., the security events that are mapped to more than one user). In examples, user metadata stored in user metadata store 246, global rules stored in global rules store 248, local rules stored in local rules store 250, user aliases stored in alias store 252, one or more match results stored in user match results store 254, security events after conversion to common format stored in common information store 256, one or more flagged rules stored in flagged rules store 258, and unmapped security events stored in unmapped security event store 260 may be periodically or dynamically updated as required.

Referring again to FIG. 2, in some embodiments, user device 206-(1-M) may be any IT device used by a user (all devices of user device 206-(1-M) are subsequently referred to as user device 206-1 but the description may be generalized to any of user device 206-(1-M)). The user may be an employee of an organization, a client, a vendor, a customer, a contractor, a system administrator, or any person associated with the organization. User device 206-1 may be any computing device, such as a desktop computer, a laptop, a tablet computer, a mobile device, a Personal Digital Assistant (PDA), or any other computing device. In an implementation, user device 206-1 may be a device, such as client device 102 shown in FIG. 1A and FIG. 1B. User device 206-1 may be implemented by a device, such as computing device 100 shown in FIG. 1C and FIG. 1D. According to some embodiments, user device 206-1 may include processor 262-1 and memory 264-1. In an example, processor 262-1 and memory 264-1 of user device 206-1 may be CPU 121 and main memory 122, respectively, as shown in FIG. 1C and FIG. 1D. User device 206-1 may also include user interface 266-1, such as a keyboard, a mouse, a touch screen, a haptic sensor, a voice-based input unit, or any other appropriate user interface. It shall be appreciated that such components of user device 206-1 may correspond to similar components of computing device 100 in FIG. 1C and FIG. 1D, such as keyboard 126, pointing device 127, I/O devices 130a-n and display devices 124a-n. User device 206-1 may also include display 268-1, such as a screen, a monitor connected to the device in any manner, or any other appropriate display, which may correspond to similar components of computing device 100, for example display devices 124a-n. In an implementation, user device 206-1 may display received content (for example, a simulated phishing communication based on a simulated phishing template) for the user using display 268-1 and is able to accept user interaction via user interface 266-1 responsive to the displayed content.

Referring again to FIG. 2, in some embodiments, user device 206-1 may include email client 270-1 and application client 272-1. In one example, email client 270-1 may be a cloud-based application that can be accessed over network 290 without being installed on user device 206-1. In an implementation, email client 270-1 may be any application capable of composing, sending, receiving, and reading email messages. In an example, email client 270-1 may facilitate a user to create, receive, organize, and otherwise manage email messages. In an implementation, email client 270-1 may be an application that runs on user device 206-1. In some implementations, email client 270-1 may be an application that runs on a remote server or on a cloud implementation and is accessed by a web browser. For example, email client 270-1 may be an instance of an application that allows viewing of a desired message type, such as any web browser, Microsoft Outlook™ application (Microsoft, Mountain View, California), IBM® Lotus Notes® application, Apple® Mail application, Gmail® application (Google, Mountain View, California), WhatsApp™ (Facebook, Menlo Park, California), a text messaging application, or any other known or custom email application. In an example, a user of user device 206-1 may be mandated to download and install email client 270-1 on user device 206-1 by the organization. In an example, email client 270-1 may be provided by the organization as default. In some examples, a user of user device 206-1 may select, purchase and/or download email client 270-1 through an application distribution platform. In some examples, user device 206-1 may receive simulated phishing communications via email client 270-1. User device 206-1 may also include application client 272-1. In an implementation, application client 272-1 may be a client side program or a client side application that is run on user device 206-1. In examples, application client 272-1 may be a desktop application, mobile application, etc. Other user devices 206-(2-M) may be similar to user device 206-1.

Referring back to FIG. 2, in some embodiments, administrator device 208 may be any device used by a system administrator to perform administrative duties. Administrator device 208 may be any computing device, such as a desktop computer, a laptop, a tablet computer, a mobile device, a Personal Digital Assistant (PDA), smart glasses, or any other computing device. In an implementation, administrator device 208 may be a device, such as client device 102 shown in FIG. 1A and FIG. 1B. Administrator device 208 may be implemented by a device, such as computing device 100 shown in FIG. 1C and FIG. 1D. According to some embodiments, administrator device 208 may include processor 274 and memory 276. In an example, processor 274 and memory 276 of administrator device 208 may be CPU 121 and main memory 122, respectively, as shown in FIG. 1C and FIG. 1D. Administrator device 208 may also include user interface 278, such as a keyboard, a mouse, a touch screen, a haptic sensor, a voice-based input unit, or any other appropriate user interface. It shall be appreciated that such components of administrator device 208 may correspond to similar components of computing device 100 in FIG. 1C and FIG. 1D, such as keyboard 126, pointing device 127, I/O devices 130a-n and display devices 124a-n. Administrator device 208 may also include display 280, such as a screen, a monitor connected to the device in any manner, a wearable glass, or any other appropriate display. In some implementations, administrator device 208 may include an administrator interface 282. Administrator interface 282 may be supported by a library, an application programming interface (API), a set of scripts, or any other code that may enable the system administrator to manage security awareness and training platform 202 and association system 204.

In an implementation, data sources 210-(1-N) may be sources within (and sometimes outside) the organization that maintain data related to users in the organization (referred to as “user data”). The data includes one or more user data records of one or more users. Each of the one or more user data records include one or more user attributes of one or more users of the organization. In examples, data sources 210-(1-N) may be related to any aspect of the organization, such as a security data source, a business operations data source, an asset management data source, or a user and identity data source. In an example, data sources 210-(1-N) may be cloud-based security software. Examples of a security data source are endpoint security systems such as CrowdStrike Falcon, SentinelOne Singularity, Kaspersky Endpoint Security, or Broadcom Symantec Endpoint Protection. Examples of a business operations data source are human capital management (HCM) applications such as Oracle HCM, SAP HCM, or Workday, IT incident applications such as ServiceNow, or sales and finance applications such as Salesforce or SAP. Examples of an asset management data source are ServiceNow, or Microsoft Dynamics. Examples of user and identity data source are Microsoft Active Directory. In some examples, data sources 210-(1-N) may be synchronized and may share information between them and in other examples, data sources 210-(1-N) may be isolated and standalone.

In an implementation, data sources 210-(1-N) may include user data in the form of a collection of user attributes and in the form of a record. A user attribute is a piece of information that is associated with the user. The form of record represents the user in the data source. In examples, each data source 210-(1-N) may be realized as a database, as a spreadsheet, as a file, or by any other electronic means which may be parsed by an algorithm running on a computer system. Examples of a user attribute include a name, an email address, an email aliases, a reporting structure (manager and subordinates), a network username, an IT application username, a role within a network (e.g., system administrator, user, superuser), networks permissions, user devices (e.g., hostnames, cell phone IMEI), installed software, and endpoint security software. Each data source 210-(1-N) may store information in a format that is specific to the application or the database which is managing data source 210-(1-N). Each record in data source 210-(1-N) may be referred to as a user data record.

According to an embodiment, security endpoints 212-(1-0) may be systems that are implemented by an organization to monitor nodes or endpoints of the network that are closest to an end user device, for example for compliance with security standards. An ‘endpoint’ is any device that is physically an end point on a computer network. Examples of endpoints are laptops, desktop computers, mobile phones, tablet devices, servers, and virtual environments. Examples of endpoint security services provided by an endpoint security system include antivirus software, email filtering, web filtering, and firewall services. In an example, security endpoints 212-(1-0) may also provide protection from cybersecurity threats posed by lack of compliance with security standards on the endpoints. In an implementation, each of security endpoints 212-(1-0) may include a secure email gateway or other system deployed by an organization. In an example, security endpoints 212-(1-0) may be third-party systems. In an implementation, security endpoints 212-(1-0) may operate to protect the organization by detecting, intercepting, or recording risky actions of users of the organization. In an implementation, security endpoints 212-(1-0) may be configured to block or record user actions that may expose the organization to risk or that may violate the policies or rules of the organization. Examples of activities that security endpoints 212-(1-0) may block or record include network traffic going to Uniform Resource Locators (URLs) that are not allowed (i.e., that are blacklisted), peer to peer traffic connecting to certain ports, user access to an insecure File Transfer Protocol (FTP) server, a direct terminal connection (for example, with telnet) with unencrypted traffic, use of unencrypted protocols (for example, http://) when encrypted protocols (for example, https://) are available, violation of company security policies (for example, the use of thumb drives or use of certain file extensions), execution of unsigned code, execution of code downloaded from the Internet, and traffic from non-secure networks (for example, not using a Virtual Private Network (VPN) to connect to devices). Known examples of security endpoints 212-(1-0) include CrowdStrike™ Falcon (Austin, Texas), Palo Alto Networks (Santa Clara, California), NetSkope NewEdge (Santa Clara, California), Zscaler (San Jose, California), SentinelOne Singularity Platform (Mountainview, California), Kaspersky Endpoint Security (Moscow, Russia), or Broadcom Symantec Endpoint Protection (San Jose, California).

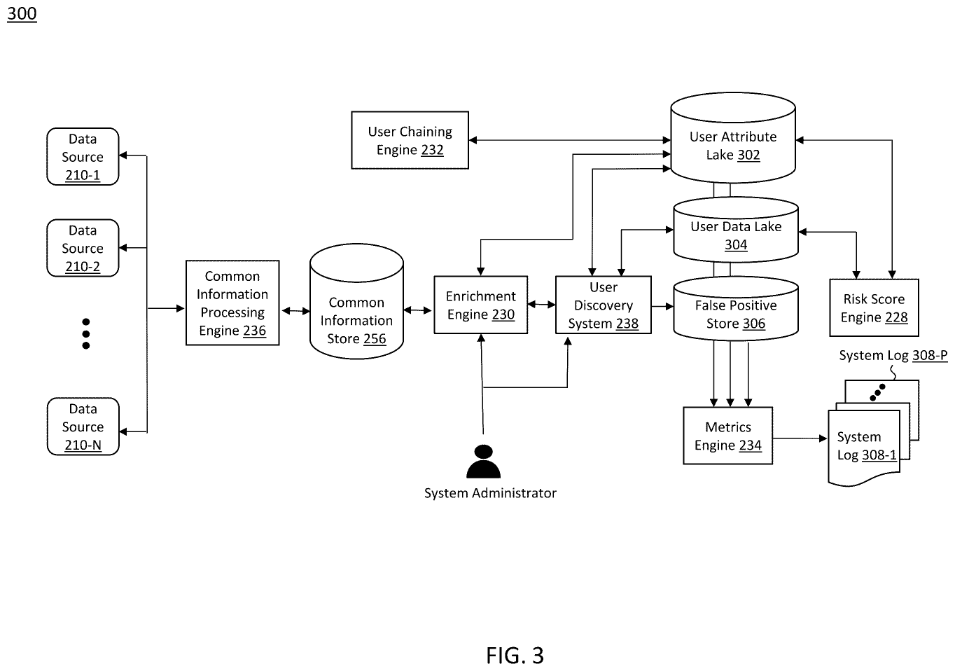

FIG. 3 illustrates flow diagram 300 of a user discovery and identification process, according to some embodiments.

According to an implementation, common information processing engine 236 may convert user data in one or more user data records from data sources 210-(1-N) into a common format to ensure that the format of the user data records is consistent. Common information store 256 may store the user data records after conversion into the common format.

In an implementation, enrichment engine 230 may periodically or on-demand perform collation, cross-referencing, and/or correlation of user data records stored in common information store 256. Each of the one or more user data records may include one or more user attributes of one or more users of an organization. Using the one or more user data records, enrichment engine 230 may, in some examples, automatically perform cross-referencing and/or correlation. Cross-referencing may include reviewing the one or more user data records having one or more user attributes to identify attributes that may appear to have some similarity.

According to an implementation, user chaining engine 232 may be communicatively coupled to user attribute lake 302. In an example, user attribute lake 302 may include master user data records from enrichment engine 230. In examples, there may be exactly one master user data record for each user and the master user data record may include known data about the specific user.

In the implementation, user chaining engine 232 may analyze one or more user data records to identify where there are more than one user data record which refers to one user in the organization. In an example, user chaining engine 232 may analyze the same user attributes between different user data records to determine those user data records which are identical and/or those user data records which are similar. In some examples, user chaining engine 232 may use a threshold, above which the user attributes being compared may be considered to refer to the same user in the organization.

When there is a security event, user discovery system 238 may attempt to identify a user associated with the security event. In one example, user discovery system 238 may receive the security event from user data lake 304. In an implementation, user data lake 304 may be a data store that includes information on security events. In an example, user data lake 304 may be populated with data from one or more security endpoints, from one or more security awareness systems, from one or more other security-related systems, or a combination. An individual data record in user data lake 304 may correspond to an individual security event.

In some examples, user discovery system 238 may receive the security event directly from response processing engine 226, although data associated with the security event may be recorded in user data lake 304. In some examples, the security event includes metadata that describes the user associated with the security event. In some examples, the metadata describes the user in terms of the security system (e.g., security endpoint) which generated the security event. For example, response processing engine 226 may share a phishing incident with metadata indicating an involvement of “Mat_Joe_Champ” in an organization's intranet social media network. In an implementation, user discovery system 238 may identify that “Mat_Joe_Champ” is associated with “Mathew_joe@@example.com”. Based on the identification, user discovery system 238 may map “Mat_Joe_Champ” to “Mathew_joe@example.com”. In an implementation, risk score engine 228 may calculate a risk score for the user that is mapped by user discovery system 238. In an example, if the user already has a risk score, then risk score engine 228 may modify the risk score of the user based on the security incident and the previous score. In some implementations, user discovery system 238 may determine that an association between the user associated with the security event and the user of the organization may be a false positive association. In an implementation, user discovery system 238 may store this result in false positive store 306. In examples, a mapping is not made between the user associated with the security event and the user of the organization. According to an implementation, metrics engine 234 may receive data from one or more of user attribute lake 302, user data lake 304, and false positive store 306 and provide metrics on the function of association system 204. In examples, metrics engine 234 may generate a plurality of system logs 308-(1-P) representing activities of association system 204. In examples, system logs 308-(1-P) may be in the form of syslogs, text files, rich-text reports, portable document format (PDF) documents, word processor documents, or any other format that may include the log of activity.

According to aspects of the present disclosure, a security event should be unambiguously mapped to a single user so that the security event can be useful for security risk assessment and security awareness training assignment. According to an implementation, upon detecting a security event, association system 204 may initiate an association process and attempt to associate (or map) the security event with a user of the organization. In examples, association system 204 may be configured to associate a user with a security event based on metadata in user records stored in user metadata store 246. A security event may include one or more security event identifiers of different types. The one or more security event identifiers may represent the information associated with the security event. In an implementation, association system 204 may execute a combined rules list against the one or more security event identifiers. The combined rules list may include one or more rules. As described earlier, the combined rules list may be an aggregation of the global rules stored in global rules store 248 and the local rules stored in local rules store 250. In examples, each rule may have a rule type which may be aligned to a security event identifier type. Example of a combined rule list illustrating rules of different rule types is shown in Table 1 provided below.

TABLE 1
Example of a combined rule list illustrating rules of different rule types

| | LHS (Security Event | Security Event | |
|---|---|---|---|
| Rule # | Identifier) | Identifier/Rule Type | RHS (Metadata) |
| 1 | username(event) | username | <firstName> + <lastName> |
| 2 | email_username(event) | email username | <email_username> |
| 3 | IP_address(event) | IP address | <device_IPaddress> |
| 4 | WLAN_MAC(event) | WLAN MAC | <device_WLAN_MACaddress> |
| | | address | |
| 5 | BT_MAC(event) | BT MAC address | <device_BT_MACaddress> |

In examples, rules in the combined rule list may be grouped based on the type of information that the LHS of the rule considers (which is the rule type which aligns with the security event identifier type). The example combined rule list shown in Table 1 includes five different rule types with an example of one rule each. In examples, the format of the RHS of the rules may depend on the implementation. In an example, a JavaScript Object Notation (JSON) expression for “<firstName>+<lastName>” may be “firstName&lastName”

In an implementation, for each security event identifier of a given type, association system 204 may execute a rule of the same type to determine if the rule matches the security event identifier with any metadata in user records stored in user metadata store 246. In examples, association system 204 may execute a combined rules list. When the execution of the combined rules list generates (or creates) one or more match results for the security event to a single user, the security event may be mapped to that user. A match result may be an incident of the LHS of a rule matching the RHS of the rule. A match result may be considered together with other match results of the same security event to determine whether or not a user alias should be created or removed.

In examples, it may not be necessary for all of the security event identifiers to be matched to metadata by the rules in the combined rules list. For example, a security event may have three security event identifiers including an email username, an IP address, and a hostname. There may be a rule of type “email username” that matches the security event identifier of type “email username” to metadata associated with a user, while there are no rules of type “IP address” or “hostname”. Accordingly, the security event identifier of type “IP address” and the security event identifier of type “hostname” are not used in the security event mapping by rules, however the security event may still be mapped to a user.

In an implementation, when an unambiguous association between a user of an organization and a security event can be made, association system 204 may create or establish one or more user alias for the user, thereby associating the security event identifiers of the matched rules with the user to whom the security event is mapped to. In examples, user aliases that are established or created by association system 204 may be stored in alias store 252. In an implementation, association system 204 may provide information pertaining to the association of the security event with the user to security awareness and training platform 202 for further actions. In an implementation, when the execution of the combined rules list results in the mapping of a security event to more than one user, then no user aliases may be created, and the security event may be moved to unmapped security event store 260.

According to an implementation, association system 204 may analyze security event identifiers of subsequent security events. In examples, if security event identifiers of a security event match alias identifiers and a user is unambiguously identified, then the user may be mapped to the security event. In an implementation, if association system 204 maps a security event to a user, then association system 204 may terminate an association process for that security event. In an implementation, upon detecting a security event, alias engine 240 may initiate an association process for the security event. According to the association process, alias engine 240 may attempt to map the security event to a user. If the security event is mapped to a user, then alias engine 240 may terminate the association process for the security event.

In an implementation, if a security event is not mapped to any user of the organization, then alias engine 240 may pass the security event to rules engine 242. According to an implementation, rules engine 242 may attempt to unambiguously map the security event to a user of the organization based on one or more rules and security event identifiers of the security event. In examples, each rule may have a rule type which may be aligned to a security event identifier type. In an example, a rule may be classified either as an exact rule or as a contains rule.

For an exact rule, a security event identifier may have to match the metadata in a user record exactly. Examples of exact rules are described in Table 2 provided below.

TABLE 2
Examples of Exact Rules

| | LHS | Security Event | |
|---|---|---|---|
| | (Security Event | Identifier/ | RHS |
| Rule # | Identifier) | Rule Type | (Metadata) |
| 1 | username(event) | username | <firstName> + |
| | | | <lastName> |
| 2 | hostname(event) | hostname | <hostname> |
| 3 | email_username(event) | email username | <email_username> |

In examples, a security event identifier of a security event forms a LHS of a rule. The rule and the security event identifier may have to be of the same type. The RHS of the rule may be searched against the same type of metadata of user records. In an example, the RHS of the rule may be executed against metadata of user records until two different users are matched (which indicates that the rule cannot unambiguously map the security event to a user). At this point, rules engine 242 may terminate the execution of the rule. Also, rules engine 242 may indicate that the rule cannot unambiguously map the security event to a user. In an example, the RHS of all rules (rules of each type) may be executed against metadata of all user records (of the corresponding type). Any match results which are found may be recorded. In an example, the match results may be stored in user match results store 254. In examples, after the completion of the execution of the rules, rules engine 242 may analyze the recorded match results to determine if the security event can be mapped to a user.

In an implementation, if the same user is included in all match results across all rule types, then rules engine 242 may map the security event to the user. In some examples, match results of rules of one type may include two or more different users. However, provided that the match results of at least one rule type include only one user, rules engine 242 may map the security event to that user. In an implementation, rules engine 242 may execute all rule types against the metadata in user records stored in user metadata store 246. In examples, rules engine 242 may compare the match results of all unambiguous rule types. In response to determining that the match results of all unambiguous rule types include the same user, then rules engine 242 may map the security event to that user. In examples, if no match results are returned from any rule type or if all rule types produce ambiguous match results (i.e., within the same rule type, execution of the rules results in match results including two or more users), then the security event may be stored in unmapped security event store 260.

In examples, a security event identifier of type “email username” may be provided to a rule of the same type (forming the LHS of the rule). In an example, email usernames assigned to users of the organization (as included in corresponding user records in user metadata store 246) may form the RHS of the rule. Based on the example, for an exact rule, a match result may be recorded when the security event identifier of type “email username” exactly matches with an email username of a user of the organization. For example, a security event identifier of type “email username” may be “jsmith”. The security event identifier “jsmith” may be used as the LHS of the rule of type “email username”. In the example, no other security event identifiers may be present.

In examples, there may be one or more user records for a user “John Smith” in user metadata store 246. The one or more user records may include an email address “jsmith@XYZ.com”, an email username “jsmith”, and a hostname “XYZ.com”. In an implementation, rules engine 242 may execute Rule #3 (described in Table 2, which is a rule of the same type as the security event identifier (i.e., “email username”)) against the metadata of type “email username” in the user record for the user “John Smith”. According to an implementation, execution of Rule #3 against the metadata of type “email username” in the user record for the user “John Smith” may result in the following:

$$\\ \begin{matrix}Rule \#3 : jsmith = jsmith \to security event is matched to John Smith\end{matrix} \\ \begin{matrix}\end{matrix}$$

According to an implementation, rules engine 242 may execute the security event identifier “jsmith” against metadata of the type “email username” in user records for other users to determine if the security event match to any other user of the organization. If no other match result is found or determined, then rules engine 242 may associate the security event identifier “jsmith” with the user “John Smith”, and create a user alias for the user.

In examples, a security event may be detected on a device with one or more identifying metadata, and a security event identifier type may be an identifier of a device. In an example, the security event identifier type may be “IP address” or “MAC address”. In examples, the security event identifier of type “IP address” may be assigned to the LHS of one or more rules with type “IP address”. In an implementation, rules engine 242 may execute the security event identifier of type “IP address” against metadata in user records of type “IP address”. If two or more match results to different users are found, then rules of type “IP address” cannot be used to unambiguously map a user to the security event.

In examples, a security event may have a security event identifier type of an intranet social media network handle (interchangeably referred to as a type “handle”) and no other types of security event identifiers may be present. An example rule of type “handle” is described in Table 3 provided below.

TABLE 3
Example rule of type “handle”

| | LHS (Security Event | Security Event | |
|---|---|---|---|
| Rule # | Identifier) | Identifier/Rule Type | RHS (Metadata) |
| 1 | handle(event) | Handle | <handle> |

In examples, a security event identifier of type “handle” may be “Mat_Joe_Champ”. The rule of the same type as the security event identifier may be Rule #1 described in Table 3. In an implementation, rules engine 242 may execute the Rule #1 to attempt to match the security event identifier to metadata in one or more user records in user metadata store 246. In an example, there may be one or more user records for a user “Matthew Joe” in user metadata store 246. The one or more user records may include an email address “mjoe@ABC.com”, an email username “mjoe”, and a handle “Mat_Joe_Champ”. In an implementation, execution of Rule #1 described in Table 3 against the user records may return a match to a single user “Matthew Joe”. In an implementation, rules engine 242 may create a match result between the security event identifier of type “handle” and the user “Matthew Joe”.

According to an implementation, as rules engine 242 uniquely identifies the user associated with the security event and there are no other security event identifiers of any type, rules engine 242 may map the security event to the user “Matthew Joe”. In some implementations, rules engine 242 may provide information pertaining to the identification of the mapping between the security event and the user “Matthew Joe” to security awareness and training platform 202. In response, security awareness and training platform 202 may adjust the risk score of the user “Matthew Joe”, for example, based on a current risk score and an assessment of the severity of the security event. In examples, mapping of the security event to the user “Matthew Joe” may trigger other security actions by security awareness and training platform 202 or other security systems in the organization.

As described earlier, a rule may be classified either as an exact rule or as a contains rule. According to contains rule, a matching user metadata entry may have to contain a security event identifier, but may additionally have other, non-conflicting metadata. In examples, a contains rule may have a greater probability of creating ambiguity in the association of a security event with a single user. Examples of contains rules are described in Table 4 provided below.

TABLE 4
Examples of contains rules

| | LHS | Security Event | |
|---|---|---|---|
| | (Security Event | Identifier/ | RHS |
| Rule # | Identifier) | Rule Type | (Metadata) |
| 1 | username- | username contains | <firstName> + |
| | contains(event) | | <lastName> |
| 2 | hostname- | hostname contains | <hostname> |
| | contains(event) | | |
| 3 | email_username- | email username | <email_username> |
| | contains(event) | contains | |

As with exact rules, if non-conflicting match results are found between contains rules of all security event identifier types, then an unambiguous mapping may be found. In examples, rules engine 242 may map the user to the security event. Similarly, if non-conflicting match results are found for a single security event identifier type (even if there are conflicting match results of other security event indicator types), then rules engine 242 may map the user of the non-conflicting match result to the security event.

In examples, a contains rule may be structured in different ways. According to an example structure (referred to as “example structure A”), a contains rule may be structured such that the RHS of the contains rule may be the security event identifier and the LHS of the contains rule may be the user metadata. In this example, the structure of the contains rule may be “<metadata> IS CONTAINED IN<security event identifier>”. According to another example structure (referred to as “example structure B”), a contains rule may be structured such that the LHS of the contains rule may be security event identifier and the RHS of the contains rule may be user metadata. In this example, the structure of the contains rule may be “<Security Event Identifier> CONTAINS<metadata>”.

In an implementation, a contains rule may result in an ambiguous mapping. For example, a security event identifier of type “user name” may be “jon”. As shown in Table 4, Rule #1 is of type “username contains”. In an example, there may be one or more user records for a user “Jon Smith” in user metadata store 246. The one or more user records for the user “Jon Smith” may include a username “Jon Smith”, an email address “jsmith@XYZ.com”, and a hostname “XYZ.com”. In some examples, one or more user records for a user “Jonathan Wright” may also be stored in user metadata store 246. The one or more user records for the user “Jonathan Wright” may include a username “Jonathan Wright”, an email address “jwright@XYZ.com”, and a hostname “XYZ.com”. In an implementation, execution of the Rule #1 of Table 4 may result in the following:

{Example Structure A}

User A - Jon Smith
Rule #1: JonSmith IS CONTAINED IN jon → Match result is created
between security event identifier and Jon Smith
User B - Jonathan Wright
Rule #1: JonathanWright IS CONTAINED IN jon → Match result is
created between security event identifier and Jonathan Wright

{Example Structure B}

User A - Jon Smith
Rule #1: jon CONTAINS JonSmith → Match result is created between
security event identifier and Jon Smith
User B - Jonathan Wright
Rule #1: jon CONTAINS JonathanWright → Match result is created
between security event identifier and Jonathan Wright

In an implementation, as illustrated in the above example, the contains rule results in ambiguity as the security event identifier of type “user name” may be mapped to the user “Jon Smith” and the user “Jonathan Wright”. Therefore, this type of contains rule cannot unambiguously map the security event to a single user. For the same security event, there may be an additional security event identifier of a different type. For example, a security event identifier may be of type “email username”, where the security event identifier may be “js”. As shown in Table 4, Rule #3 is of type “email username”. In an implementation, execution of the Rule #3 of Table 4 may result in the following:

{Example Structure A}

User A - Jon Smith
Rule #3: jsmith IS CONTAINED IN js → Match result is created between
security event identifier and Jon Smith
User B - Jonathan Wright
Rule #1: jwright IS NOT CONTAINED IN js → no match

{Example Structure B}

User A - Jon Smith
Rule #1: js CONTAINS jsmith → Match result is created between security
event identifier and Jon Smith
User B - Jonathan Wright
Rule #1: js CONTAINS jwright → no match

In examples, this type of security event identifier may result in an unambiguous match result when the contains rule of this type is executed. In examples, if the same user is found in all match results across all rule types, then rules engine 242 may make an unambiguous mapping between the security event and the user. In an example, match results of rules of one type may include two or more different users. However, provided that the match results of at least one rule type include only one user, rules engine 242 may map the security event to that user. In some examples, all rule types may be executed against the metadata in user records stored in user metadata store 246. In an implementation, rules engine 242 may compare the match results of all unambiguous rule types. If all the match results of unambiguous rule types include the same user, then rules engine 242 may map the security event to that user. In examples, if no match results are returned from any rule type or if all rule types generate ambiguous match results (i.e., within the same rule type, execution of the rules results in match results including two or more users), then the security event may be stored in unmapped security event store 260.

Examples by which association system 204 may attempt to map security events to one or more users of the organization based on existing rules stored in global rules store 248 and local rules store 250 are described in detail below.

According to an implementation, one or more security events may be provided as an input to association system 204. In examples, the one or more security events may be generated by different generating systems such as security awareness systems (including security awareness and training platform 202), endpoint security systems (including one or more security endpoints 212-(1-0)), and/or other IT systems deployed by the organization. These generating systems may interface with association system 204 via one or more application programming interfaces (API). In examples, each security event may be associated with one or more security event identifiers of one or more security event identifier types.

In examples, security events generated by different generating systems may include data (including security event identifiers) in formats that depend upon the generating systems. Prior to or during the input of the security events to association system 204, an API may process the security events to ensure that the format of the security events and their security event identifiers are consistent across all generating systems. In examples, common information processing engine 236 may process all security events prior to their input to association system 204 using a common schema compute cluster in combination with a common information model (CIM). In an implementation, common information processing engine 236 may convert the security events into a common format which is independent of the generating systems. In some implementations, common information store 256 may store the security events after conversion to the common format.

In a streaming process, one or more security event identifiers of a security event may be input to alias engine 240. In an implementation, using the one or more security event identifiers of the security event, alias engine 240 may determine whether there are any user aliases in alias store 252 that can map the one or more security event identifiers to a user. In examples, a LHS of a user alias may be referred to as an alias identifier. For example, for a user alias “<jsmith>→John Smith”, an alias identifier may be “jsmith”. In examples, alias identifiers may be classified by type, where the types of alias identifiers are aligned with the types of security event identifiers and the types of rules.

In an implementation, alias engine 240 may determine whether a security event can be unambiguously associated with a user. In response to determining that the security event can be unambiguously associated with a user, alias engine 240 may map the security event to the user. In some implementations, alias engine 240 may provide information related to the mapped security event to security awareness and training platform 202 or other security systems which can take security actions. In some implementations, alias engine 240 may fail to map a security event to a user.

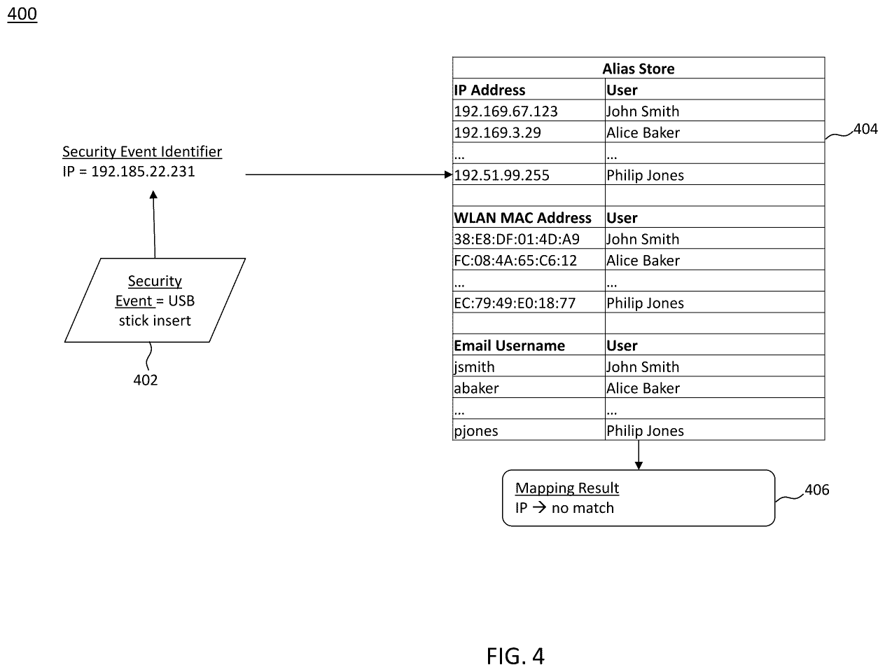

FIG. 4 illustrates flow diagram 400 of an unsuccessful security event mapping by alias engine 240 of association system 204, according to some embodiments.

In the example shown in FIG. 4, at step 402 of flow diagram 400, a security event which may be a user inserting a Universal Serial Bus (USB) stick into a laptop may be received at association system 204. In examples, a security event identifier may be associated with the security event. The security event identifier may be an IP address of the laptop (security event identifier of type “IP address”). In the example shown in FIG. 4, the security event identifier of type “IP address” is “192.185.22.231”. In an implementation, upon receiving the security event, association system 204 may invoke alias engine 240.

At step 404 of flow diagram 400, alias engine 240 may analyze the security event identifier of type “IP address” against information stored in alias store 252 (i.e., against user aliases with the same alias identifier type as the security event identifier type).

At step 406 of flow diagram 400, alias engine 240 may determine that there is no alias identifier of a user alias in alias store 252 that matches to the security event identifier. As a result, alias engine 240 returns no mapping result. In the example shown in FIG. 4, the security event identifier “192.185.22.231” does not match to any alias identifier in alias store 252. In an implementation, association system 204 next invokes rules engine 242. In an implementation, association system 204 may execute rules engine 242 on security event identifiers of different types.

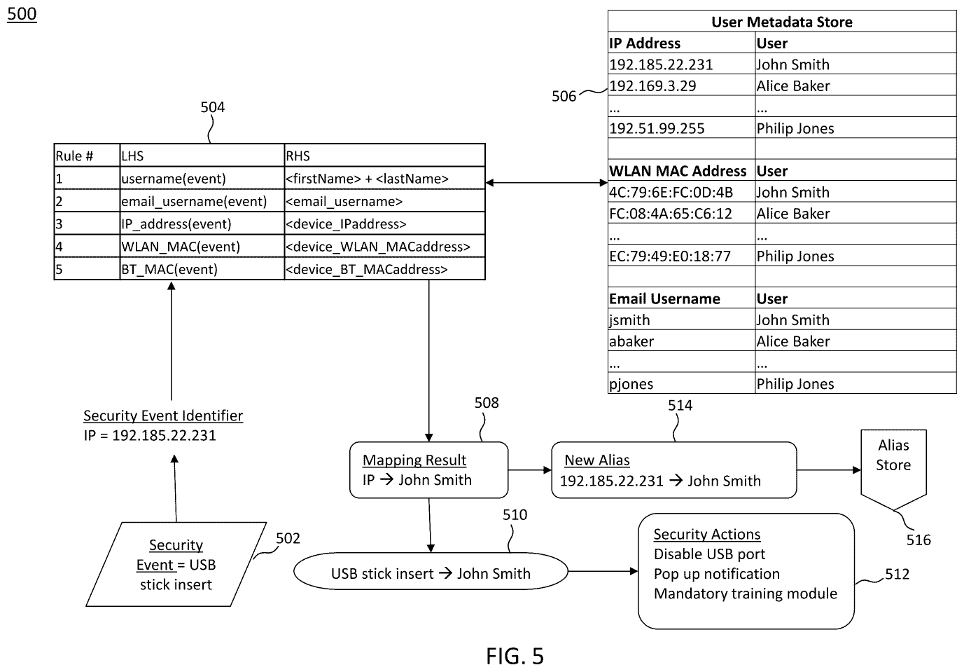

FIG. 5 illustrates flow diagram 500 of an execution of rules engine 242 of association system 204 against a security event, according to some embodiments.

In the example shown in FIG. 5, at step 502 of flow diagram 500, a security event which may be a user inserting a USB stick into a laptop may be received. In the example shown in FIG. 5, a security event identifier associated with the security event is “192.185.22.231”. In examples, a single security event identifier of type “IP address” may be passed to rules engine 242.

At step 504 of flow diagram 500, rules engine 242 may identify rules of the same type as the security event identifier. In the combined rules list (504), Rule #3 is a rule of type “IP_address”.

At step 506 of flow diagram 500, rules engine 242 may take the security event identifier of type “IP address” and execute rules of the same type (in the example, this is Rule #3) on metadata in user records stored in user metadata store 246, thereby creating a list of match results. In an implementation, rules engine 242 may execute a combined rule list on the metadata in the user records.

At step 508 of flow diagram 500, rules engine 242 may determine that Rule #3 of and of type “IP address” of the combined rule list (504) results in a match result of the security event identifier of type “IP address” associated with the user “John Smith”. This is shown as mapping result 508 in FIG. 5. In an example, since there are no contradictory match results from the execution of Rule #3 of the combined rule list (504) and there are no security event identifiers of other types, the security event may be mapped to the user “John Smith”.

At step 510 of flow diagram 500, rules engine 242 may determine that the user “John Smith” inserted the USB stick into the laptop, that is, the security event “USB stick insert” is associated with the user “John Smith”.

At step 512 of flow diagram 500, rules engine 242 may provide the mapping result to security awareness and training platform 202 (and optionally to other security systems of the organization). In an implementation, security awareness and training platform 202 (or other security system of the organization) may take one or more security actions based on the mapping result. In examples, security awareness and training platform 202 may disable a USB port into which the USB stick was inserted. In the example of FIG. 5, security awareness and training platform 202 may disable the USB port of the users device of “John Smith” that has the IP address “192.185.22.231”. In some examples, security awareness and training platform 202 may provide a popup notification on the display of the device of the user “John Smith”, and require the user “John Smith” to complete one or more mandatory training modules on threats associated with USB sticks.

In the example shown in FIG. 5, based on the mapping results (508), and since there are no other types of security event identifiers present, a new user alias may be created that associates the security event identifier “192.185.22.231” of type “IP Address” to the user “John Smith”. The newly created user alias may be stored in alias store 516, which is an example of alias store 252.

In an implementation, rules engine 242 may analyze stored rules of one type at a time. In examples, to execute rules to match security event identifiers to user metadata in user records, the user metadata of the same type as the rule may be stored as strings in a trie structure. A trie structure is a type of k-ary search tree used for storing and searching a specific key from a set. In an example, each node of a trie structure may represent a character of user metadata. In examples, rules engine 242 may use a trie structure to search for security event identifiers in the user records.

In examples, for an exact rule, trie execution starts at a root node, and a security event identifier may be found in the trie structure ending at an end node, where the end node is associated with a user.

An example of an exact rule of type “first name” is described in Table 5 provided below.

TABLE 5
Example of exact rule of type “first name”

| | LHS (Security Event | Security Event | |
|---|---|---|---|
| Rule # | Identifier) | Identifier/Rule Type | RHS (Metadata) |
| 1 | firstname(event) | first name | <firstName> |

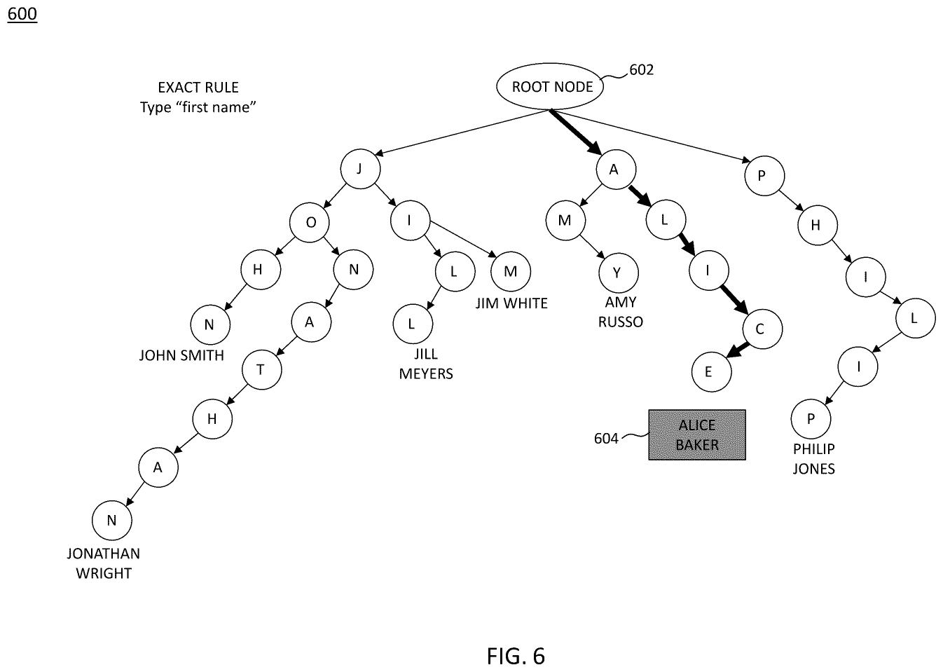

FIG. 6 illustrates example trie structure 600 for an exact rule of type “first name”, according to some embodiments. In particular, FIG. 6 describes an example of execution of rules engine 242 for an exact rule of type “first name” against a security event.

As shown in the example of FIG. 6, from root node 602 of trie structure 600, there are seven different paths through trie structure 600 for the exact rule of type “first name”. The seven different paths represent seven different users of user records which have metadata including “first name”. In examples, there is one path from root node 602 to an end node for each of the users. As shown in FIG. 6, users found as a result of the execution of the exact rule of type “first name” against user records stored in user metadata store 246 include user “John Smith” (first name “John”), user “Jonathan Wright” (first name “Jonathan”), user “Jill Meyers” (first name “Jill”), user “Jim White” (first name “Jim”), user “Amy Russo” (first name “Amy”), user “Alice Baker” (first name “Alice”), and user “Philip Jones” (first name “Philip”). In examples, if a security event with a security event identifier of type “first name” equal to “Alice” is passed to rules engine 242, then rules engine 242 may execute Rule #1 of Table 5. As a result of execution of the Rule #1, a match result of “Alice Baker,” may be returned (represented by reference numeral “604” in FIG. 6).

In examples, for a contains rule, trie execution may start at any node matching a first character or value of a security event identifier and proceed through a trie structure to find all paths where the entire security event identifier is found.

An example of a contains rule of type “first name contains” is described in Table 6 provided below.

TABLE 6
Example of contains rule of type “first name contains”

| | LHS (Security Event | Security Event | |
|---|---|---|---|
| Rule # | Identifier) | Identifier/Rule Type | RHS (Metadata) |
| 1 | firstname- | first name contains | <firstName> |
| | contains(event) | | |

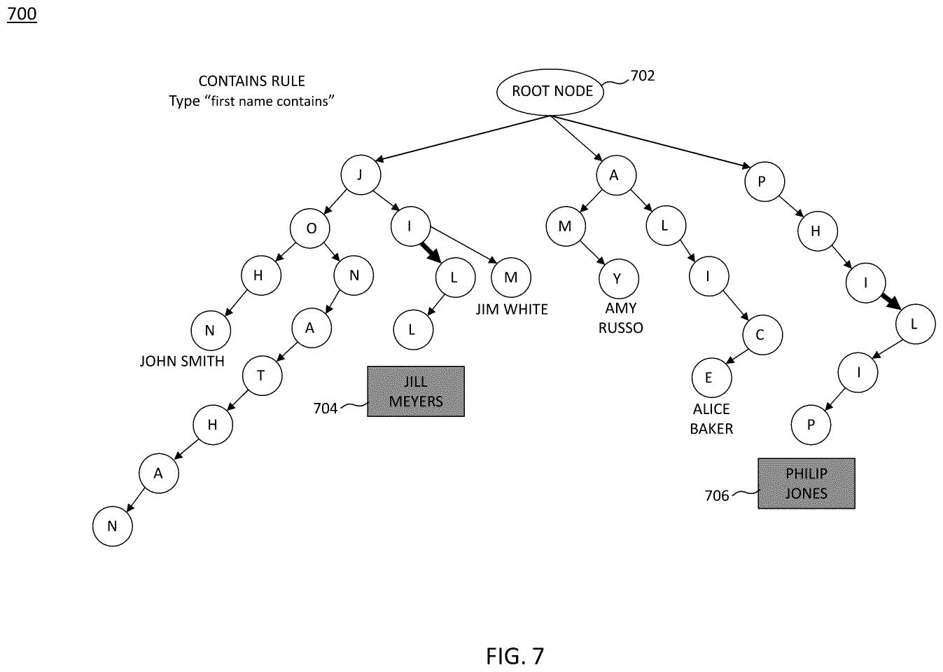

FIG. 7 illustrates example trie structure 700 for a contains rule of type “first name contains”, according to some embodiments. In particular, FIG. 7 describes an example of execution of rules engine 242 for a contains rule of type “first name contains” against a security event.

As shown in FIG. 7, users found as a result of the execution of the contains rule of type “first name contains” against user records stored in user metadata store 246 include user “John Smith” (first name “John”), user “Jonathan Wright” (first name “Jonathan”), user “Jill Meyers” (first name “Jill”), user “Jim White” (first name “Jim”), user “Amy Russo” (first name “Amy”), user “Alice Baker” (first name “Alice”), and user “Philip Jones” (first name “Philip”). In an example, there may be one path from root node 702 of trie structure 700 to an end node for each of the users. In examples, if a security event with a security event identifier of type “first name contains” equal to “il” is passed to rules engine 242, then rules engine 242 may execute Rule #1 of Table 6. As a result of execution of Rule #1, match result of “Jill Meyers” and “Philip Jones” (represented by reference numerals “704” and “706”, respectively, in FIG. 7) may be returned as the first name “Jill” includes “il” (shown with a dark arrow on FIG. 7) and the first name “Philip” includes “il” (shown with a dark arrow on FIG. 7).

In examples, contains rules inherently have a higher risk of ambiguity in mapping a security event to a user. However, whether or not a contains rule is ambiguous depends on a security event identifier that forms a LHS of a rule. In the example described in FIG. 7, if the security event identifier was “nat” instead of “il”, trie structure 700 would unambiguously match the security event identifier to “Jonathan Wright”, as that node path represents sole occurrence of a string “nat” in the first name of a user.

In examples, when new user metadata are added to the organization, a trie structure may be updated for each rule type. As a result, one or more ambiguities may be created in mapping a security event to a single user. In one scenario, a single rule may match to more than one user.

In examples, association system 204 may use an Aho-Corasick algorithm, which constructs a data structure similar to a trie structure with some additional links and then constructs a finite state machine (automaton) in O(mk) time, where k is the size of a used alphabet. For example, the Aho-Corasick algorithm may be an efficient string matching algorithm that locates all occurrences of a set of keywords within a body of text in a single pass. In examples, the Aho-Corasick algorithm may be a finite automaton-based algorithm that uses a trie structure to store the keywords and build a state machine to search for the keywords. In an example, the Aho-Corasick algorithm may start by constructing a trie structure from the set of keywords. Each node in the trie structure may represent a prefix of a keyword, and each leaf node may represent a complete keyword. The Aho-Corasick algorithm may then build a state machine by connecting each node in the trie structure to its fail node, which represents the longest proper suffix of the prefix represented by the node that is also a prefix of some other keyword. In an example, the fail node may be used to redirect the search from a node that does not lead to a keyword to a node that does. In an example, during the search, the Aho-Corasick algorithm may process the text character by character, updating the state of the machine based on the transition from the current state to its next state in the trie structure. If the next state represents a keyword, the keyword may be reported as a match result. The Aho-Corasick algorithm may continue until the entire text has been processed.

In examples, new metadata and therefore new user records may be added in user metadata store 246, for example, when new user metadata are added to the organization. As a result, one or more ambiguities may be created in mapping a security event to a single user. In one scenario, a single rule may match to more than one user. In another scenario, multiple rules may match to different users. Both these scenarios are explained in detail below.

In an implementation, a rule executed on specific security event identifiers may result in more than one match result to different users, which is undesirable (e.g., the rule may be ambiguous). In examples, the same rule may be ambiguous for some security event identifiers and unambiguous for other security event identifiers. In an example, an ambiguity may arise from an exact rule of type “first name” as a result of a new user being added to the Active Directory of the organization. In examples, when the exact rule of type “first name” was created, there may be an entry for a user “John Smith” in the Active Directory of the organization and this may be the only entry in the Active Directory with <firstName>=John. In examples, when a trie structure for this exact rule was created (for example, trie structure 600 of FIG. 6), the trie structure was unambiguous. After a period of time, a new user “John Snow” may be added to the Active Directory of the organization. In an implementation, association system 204 may send a notification to a system administrator indicating that there is a potential ambiguity for the exact rule of type “first name”. In examples, the notification may indicate which security event identifier returns ambiguous match results as a result of the updated metadata. In examples, after the update of the trie structure, a security event may occur, and a security event identifier of type “first name” may be “John”.

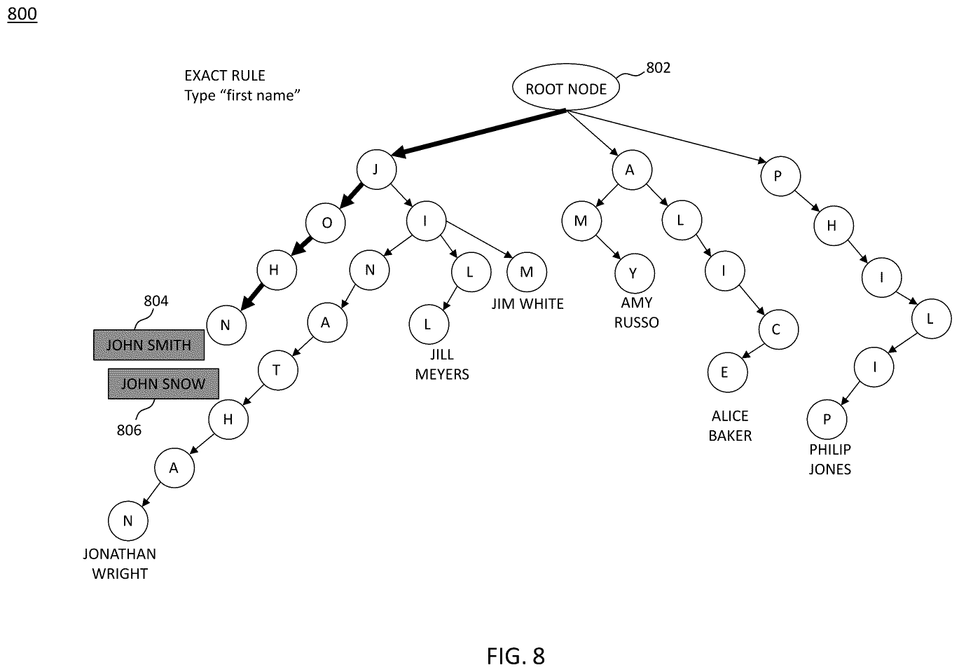

FIG. 8 illustrates example updated trie structure 800 for an exact rule of type “first name”, according to some embodiments. In particular, FIG. 8 describes updated trie structure 800 for an exact rule of type “first name” after a user “John Snow” is added to the Active Directory of the organization. In an implementation, association system 204 may update the trie structure for the exact rule of type “first name” to add the user “John Snow”. In an example, nodes of the trie structure may be unchanged, however there may be two results at the end of a path from a root node, one result being the user “John Smith” and other being the user “John Snow”. In examples, user metadata store 246 may include user records for a user “John Smith” and the user “John Snow”. In an example, there may be one path from root node 802 of trie structure 800 to an end node for each of the users. FIG. 8 illustrates an updated trie structure for the exact rule of type “first name”, where starting at a root mode of the trie structure and following the path for “John” may lead to the user “John Smith” (existing user) and the user “John Snow” (newly added user).

In an implementation, if a security event with a security event identifier “John” is passed to rules engine 242, then rules engine 242 may execute an exact rule (for example, Rule #1 of Table 5) of the same type on the metadata in user records stored in user metadata store 246. As a result of execution of the Rule #1, match results of “John Smith” and “John Snow” may be returned (represented by reference numerals “804” and “806”, respectively, in FIG. 8). In examples, execution of the Rule #1 creates an ambiguity as described below.

$$\\ \begin{matrix}Rule \#1 \text{:} John = John Smith \to Match Result is John Smith\end{matrix} \\ \begin{matrix}Rule \#1 \text{:} John = John Snow \to Match Result is John Snow\end{matrix}$$

In examples, the exact rule of type “first name” may result in an ambiguity only for the security event identifier of type “first name” equal to “John”. For other security event identifiers of type “first name”, rules engine 242 may unambiguously map the security event to a user.

According to aspects of the present disclosure, a plurality of rules stored in global rules store 248 and local rules store 250 may be reviewed periodically or on-demand to determine if one or more rules of the plurality of rules are ambiguous. In examples, the one or more ambiguous rules may be refreshed. In an example, the one or more ambiguous rules may be reviewed, removed or modified. Examples by which one or more rules may be reviewed, removed, or modified are described below.

According to an implementation, rules refresh engine 244 may execute one or more rules against one or more user records in user metadata store 246. In examples, the one or more rules may be configured to match a security event of one or more security events with a user of one or more users using user metadata. In examples, rules refresh engine 244 may execute one or more rules of a same type from a combined rule list. In an example, the one or more rules may result in an ambiguity of matching the user to the security event.

In an implementation, rules refresh engine 244 may be configured to identify a count of a number of times a rule of the one or more rules identifies a plurality of different users of the organization. In examples, rules refresh engine 244 may maintain a counter for the rule. In an example, the counter may be referred to as Count_RuleID, where RuleID is an identifier of the rule. In examples, each time the rule is ambiguous (either because a single security event identifier when processed by the rule returns more than one different match result, or because more than one different security event identifier of the same type returns the same match result), the Count_RuleID may be incremented. In examples, each time a security event identifier when processed by the rule returns an unambiguous result, the Count_RuleID may be decremented (for example, until the counter is equal to zero). In examples, to distinguish one organization's Count_RuleID for a global rule or for a rule with a given RuleID from another organization's Count_RuleID for the same global rule or rule with the same RuleID, rules refresh engine 244 may prepend the Count_RuleID value with an organization identifier, for example, ORG_Count_RuleID.

In some implementations, rules refresh engine 244 may maintain a count of a number of different match results (i.e., a number of different users) a single security event identifier returns for the rule. In an example, the count may be referred to as MR_count-RuleID, where RuleID is an identifier of the rule. In examples, to distinguish one organization's MR_count for a global rule or for a rule with a given RuleID from another organization's MR_count for the same global rule or rule with the same RuleID, rules refresh engine 244 may prepend the MR_count-RuleID value with an organization identifier, for example, ORG_MR_count-RuleID.

In some implementations, rules refresh engine 244 may be configured to maintain a count of a number of different security event identifiers that return an ambiguity for the rule. In an example, the count may be referred to as SEI_count-RuleID. In examples, to distinguish one organization's SEI_count for a global rule or for a rule with a given RuleID from another organization's SEI_count for the same global rule or rule with the same RuleID, rules refresh engine 244 may prepend the SEI_count-RuleID value with an organization identifier, for example, ORG_SEI_count-RuleID.

According to an implementation, rules refresh engine 244 may be configured to determine that one of the count of the number of times the rule identifies the plurality of different users exceeds a first threshold, or the number of the plurality of different users exceeds a second threshold, or the number of different security event identifiers that return an ambiguity for the rule exceeds a third threshold.

In examples, the first threshold for the rule may be a count threshold, and is referred to as Count_RuleID-TH. In an implementation, rules refresh engine 244 may establish the Count_RuleID-TH for the rule. In an example, rules refresh engine 244 may convert a false positive tolerance value to a Count_RuleID-TH value. A false positive occurs when an security event identifier is matched to a user however the match result is incorrect. In some examples, the system administrator of the organization may establish the Count_RuleID-TH for the rule.

In examples, the second threshold for the rule may be referred to as MR_count-RuleID-TH. In an implementation, rules refresh engine 244 may establish the MR_count-RuleID-TH for the rule. In an example, rules refresh engine 244 may convert a false positive tolerance value to a MR_count-RuleID-TH value. In examples, the system administrator of the organization may establish the MR_count-RuleID-TH for the rule.

In examples, the third threshold for the rule may be referred to as SEI_count-RuleID-TH. In an implementation, rules refresh engine 244 may establish the SEI_count-RuleID-TH for the rule. In an example, rules refresh engine 244 may convert a false positive tolerance value to a SEI_count-RuleID-TH value. In examples, the system administrator of the organization may establish the SEI_count-RuleID-TH for the rule.

According to some implementations, rules refresh engine 244 may determine an ambiguity score for the rule. In examples, the ambiguity score may be defined as a portion that the rule is ambiguous compared to a portion the rule is unambiguous. In an example, the ambiguity score may be referred to as AS_RuleID. In examples, the ambiguity score of the rule may be determined based at least on the count of the rule, for example, the SEI_count of the rule or the MR_count of the rule. In examples, when the ambiguity score of the rule is based on SEI_count, the ambiguity score may be referred to as AS-SEI_RuleID, and when the ambiguity score of the rule is based on MR_count, the ambiguity score may be referred to as AS-MR_RuleID. In examples, to distinguish one organization's AS-SEI_RuleID or AS-MR_RuleID for a global rule or for a rule with a given RuleID from another organization's AS-SEI_RuleID or AS-MR_RuleID for the same global rule or rule with the same RuleID, rules refresh engine 244 may prepend the AS-SEI_RuleID or AS-MR_RuleID value with an organization identifier, for example, ORG_AS-SEI_RuleID or ORG_AS-MR_RuleID.

In examples, threshold for AS-SEI_RuleID may be referred to as AS-SEI_RuleID-TH and threshold for AS-MR_RuleID may be referred to as AS-MR_RuleID-TH. In an implementation, rules refresh engine 244 may establish the AS-SEI_RuleID-TH or AS-MR_RuleID-TH. In an example, rules refresh engine 244 may convert a false positive tolerance value to a AS-SEI_RuleID-TH value or AS-MR_RuleID-TH value. In examples, the system administrator of the organization may establish the AS-SEI_RuleID-TH or AS-MR_RuleID-TH.

According to an implementation, in response to determining that one of the count of the number of times the rule identifies the plurality of different users exceeds the first threshold, or the number of the plurality of different users exceeds the second threshold, or the number of different security event identifiers that return an ambiguity for the rule exceeds the third threshold, rules refresh engine 244 may flag the rule for display to the system administrator.

The description above is explained with reference to a single rule only for the purpose of explanation, it should not be construed as a limitation, and it is appreciated that the above description may also be applicable to one or more other rules, and as a result one or more other rules may be flagged by rules refresh engine 244. In an example, the flagged rules may be stored in flagged rules store 258 for later use.

According to an implementation, rules refresh engine 244 may display the flagged rules to the system administrator. In examples, rules refresh engine 244 may display the flagged rules to the system administrator based on a schedule. A schedule may be a timing or a periodicity for displaying the flagged rules to the system administrator. In examples, the schedule may be configurable by rules refresh engine 244. In some examples, the schedule may be configurable by the system administrator. Examples of the schedule include, but are not limited to, immediate, end of day, end of week, daily, and monthly. In examples, rules refresh engine 244 may display the flagged rules to the system administrator based on an action of the system administrator in a user interface (for example, administrator interface 282). In some examples, rules refresh engine 244 may display the flagged rules to the system administrator responsive to a number of flagged rules exceeding a threshold value.

In an implementation, rules refresh engine 244 may display each flagged rule via a user interface to prompt an action to one or more of review, remove or modify the rule by the system administrator. In some implementations, rules refresh engine 244 may not flag the rules and rules may be displayed to the system administrator as soon as the determination is made.

According to an implementation, rules refresh engine 244 may display the SEI_count-RuleIDs of one or more flagged rules to the system administrator. In examples, rules refresh engine 244 may display the SEI_count-RuleID for a specific rule to the system administrator only when the SEI_count-RuleID exceeds the SEI_count-RuleID-TH for that rule. In an example, rules refresh engine 244 may automatically delete or remove a rule if the SEI_count-RuleID exceeds the SEI_count-RuleID-TH for that rule. In an implementation, rules refresh engine 244 may disable a rule if the SEI_count-RuleID exceeds the SEI_count-RuleID-TH for that rule. In an example, the rule may be displayed to the system administrator shown in a disabled state along with one or more reasons that the rule has been disabled. In examples, the system administrator may choose to remove a rule that is in a disabled state. In examples, if a rule is ambiguous for few security event identifiers but is unambiguous for a majority of security event identifiers, then removal of the rule may not be desirable. In such scenarios, the rule may be modified or a recommendation to modify the rule may be made to the system administrator.

In some implementations, rules refresh engine 244 may display the MR_count-RuleIDs of one or more flagged rules to the system administrator. In an implementation, rules refresh engine 244 may display the MR_count-RuleID for a specific rule to the system administrator only when the MR_count-RuleID exceeds the MR_count-RuleID-TH for that rule. In an example, rules refresh engine 244 may automatically remove a rule if the MR_count-RuleID exceeds the MR_count-RuleID-TH for that rule. In an implementation, rules refresh engine 244 may disable a rule if the MR_count-RuleID exceeds the MR_count-RuleID-TH for that rule. In an example, the rule may still be displayed to the system administrator but is shown in a disabled state along with one or more reasons that the rule has been disabled. In examples, the system administrator may choose to remove or modify a rule that is in a disabled state.

According to some implementations, rules refresh engine 244 may display the Count-RuleIDs of one or more flagged rules to the system administrator. In examples, rules refresh engine 244 may display the Count-RuleID for a specific rule to the system administrator only when the Count-RuleID exceeds the Count-RuleID-TH for that rule. In an implementation, rules refresh engine 244 may automatically remove a rule if the Count-RuleID exceeds the Count-RuleID-TH for that rule. In examples, rules refresh engine 244 may disable a rule if the Count-RuleID exceeds the Count-RuleID-TH for that rule. In an example, the rule may still be displayed to the system administrator but is shown in a disabled state along with one or more reasons that the rule has been disabled. In examples, the system administrator may choose to remove a rule that is in a disabled state.

According to some implementations, rules refresh engine 244 may display the AS-SEI_RuleIDs or AS-MR_RuleIDs of one or more flagged rules to the system administrator. In an implementation, rules refresh engine 244 may display the AS-SEI_RuleID or AS-MR_RuleID for a specific rule to the system administrator only when the AS-SEI_RuleID exceeds the AS-SEI_RuleID-TH for that rule, or when the AS-MR_RuleID exceeds the AS-MR_RuleID-TH for that rule.

In an implementation, rules refresh engine 244 may determine a ranked list of one or more rules to one or more of review, remove or modify. According to an implementation, rules refresh engine 244 may display the ranked list of the one or more rules to the system administrator via a user interface to prompt an action to one or more of review, remove or modify the one or more rules by the system administrator.

In examples, rules refresh engine 244 may display two or more rules to the system administrator in ranked order of their SEI_count-RuleID. In an implementation, rules refresh engine 244 may provide one or more deletion recommendations for one or more rules to the system administrator based on the ranked order of the rules and their SEI_count-RuleID.

In some examples, rules refresh engine 244 may display two or more rules to the system administrator in ranked order of their MR_count-RuleID. In an implementation, rules refresh engine 244 may provide one or more deletion, modification, removal or disable recommendations for one or more rules to the system administrator based on the ranked order of the rules and their MR_count-RuleID. In some examples, rules refresh engine 244 may display two or more rules to the system administrator in ranked order of their Count-RuleID. In an implementation, rules refresh engine 244 may provide one or more deletion, modification, removal or disable recommendations for one or more rules to the system administrator based on the ranked order of the rules and their Count-RuleID.

According to some implementations, rules refresh engine 244 may display rules to the system administrator along with their ambiguity scores. In examples, rules and their ambiguity scores may be displayed to the system administrator in ranked order of highest ambiguity score to lowest ambiguity score. In an example, only the top 10 rules (ranked on the ambiguity score of the rule) may be displayed to the system administrator to prompt an action to one or more of review, remove or modify the rules.

In some examples, rules refresh engine 244 may display two or more rules to the system administrator in ranked order of their AS-SEI_RuleID or AS-MR_RuleID. In an implementation, rules refresh engine 244 may provide one or more deletion, modification, removal or disable recommendations for one or more rules to the system administrator based on the ranked order of the rules based on their AS-SEI_RuleID or AS-MR_RuleID. In an example, if the AS-SEI_RuleID or AS-MR_RuleID of a rule exceeds a threshold, then the system administrator may remove the rule. In examples, if a rule is overly broad, as may for example be the case with a contains rule, then there may be a large number of ambiguities with the rule. In examples, a different threshold may be set for contains rules than for exact rules.

According to some implementations, the system administrator of the organization may indicate the organization's tolerance of false positive results (which may be referred to as FP_tol) in the configuration of association system 204. In examples, to distinguish one organization's tolerance of false positive results from another organization's tolerance of false positive results, association system 204 may prepend the FP_tol value with an organization identifier, for example, ORG_FP_tol. In an example, the organization's tolerance of false positive results may be expressed as a percentage value. In an implementation, association system 204 may provide information to the system administrator that a rule is ambiguous. In examples, this information may be used to enable the system administrator to review the rule and determine whether the rule should be kept, modified or removed.

According to some implementations, a single rule may not result in an ambiguity. However, two or more rules may result in an ambiguity. This may occur for example because additional rules may be added to association system 204, for example, by the system administrator, which may introduce a mapping ambiguity. An example of a scenario where such an ambiguity arises with exact rules is described in Table 7 provided below. In this example, Rule #1 previously existed, and Rule #2 is newly added, for example, by the system administrator.

TABLE 7
Example exact rule

| | LHS | Security Event | |
|---|---|---|---|
| | (Security Event | Identifier/ | |
| Rule # | Identifier) | Rule Type | RHS (Metadata) |
| 1 | firstname(event) | first name | <firstName> |
| 2 | email_username(event) | email username | <email_username> |

In an example, a security event may occur and a security event indicator of type “first name” of the security event may be “James”. In examples, there may be one or more user records for a user “James Jones” in user metadata store 246. The one or more user records for the user “James Jones” may include a first name “James” and an email address “jones@company.com”. In examples, there may be one or more user records for a user “Ron James” in user metadata store 246. The one or more user records for the user “Ron James” may include a first name “Ron” and an email address “james@company.com”. This may create ambiguities as shown below.

$$\\ \begin{matrix}Rule \#1 : James = James Jones \to Match Result is James Jones\end{matrix} \\ \begin{matrix}Rule \#2 : James = james @ company . com \to Match Result is Ron James\end{matrix}$$

According to an implementation, rules engine 242 may execute all rules from the combined rule list against all the security event identifiers of the security event. In examples, returned users may be stored as match results in user match results store 254. In an example, if two or more different match results are created as a result of execution of the combined rule list, then all match results may be rejected. In an implementation, rules engine 242 may display rules of the combined rule list together with the match results of the rules to the system administrator for review. In examples, if match results are created as a result of execution of the combined rule list, then rules engine 242 may map the security event to the user of the match results.

According to some implementations, rules engine 242 may execute all rules against all user records in user metadata store 246. In examples, where a match result occurs, the user of the match result may be recorded as an entry in a MatchResultVector. In an example, if the rule does not result in a match result, then no entry is added to the MatchResultVector. Once all rules have been executed, rules engine 242 may check entries of the MatchResultVector to determine if they are all identical. In examples, this may be implemented using a Python code (function) as described below.

$$\\ \begin{matrix}def one\_user ( MatchResultVector ) \text{} : \\ return len ( set ( MatchResultVector ) ) == 1 \\ MathResultVector = [ ‘ user 1 ’ , ‘ user 2 ’ , ‘ user 3 ’ , … ‘ user R ’ ] \\ result = one\_user ( MatchResult Vector ) \\ print ( result )\end{matrix} \\ \begin{matrix}\end{matrix}$$

The Python code defines a function called “one_user” which takes the vector of matching rule results (i.e., the MatchResultVector) as an argument. The “one_user” function may initially use the “set( )” function to create a deduplicated set from the elements of MatchResultVector. Thereafter, the “one_user” function may use the “len( )” function to count the number of elements in the set. In examples, “one_user” function may compare the number of elements to “1” using the “==” operator. If the “one_user” function returns “True”, then the number of elements in the deduplicated set of match results may be “1”, and there may be no ambiguity. If the “one_user function” returns “False”, then the number of elements in the deduplicated set of match results may be greater than “1”, and there may be an ambiguity.

In some implementations, rules engine 242 may execute rules from the combined rule list in sequence until two match results are obtained (referred to in this example as “Match1” and “Match2”). In an implementation, rules engine 242 may compare the two match results to each other to determine if the two match results are identical. In examples, this may be implemented using a Python code as described below.

$$\\ \begin{matrix}text 1 = ‘ Match 1 ’ \\ text 2 = ‘ Match 2 ’ \\ result = text 1 == text 2 \\ print ( result )\end{matrix}$$

In the example described above, the Python code defines two variables “text1” and “text2” and assigns these two variables to the two match results. The Python code may then use the “==” operator to compare the two match results. If the match results are same, then comparison returns “True”. One of the match results may then be discarded, and rules engine 242 may process the next rules in the sequence until another match result is found, repeating this comparison. If no other match result is found, then the security event may be unambiguously mapped to a user. In an example, if the match values are different, the comparison returns “False”. At this point, rules engine 242 may stop processing of the rules and may not map the security event to a user.

According to some implementations, rules engine 242 may execute one or more rules from the combined rule list of the same type. If two or more match results are obtained, then rules engine 242 may compare the match results to each other to determine if the match results are identical. If the match results are found to be identical, rules engine 242 may retain one match result and execute rules from the combined rule list of other types. If two or more of the match results are found to be different, then rules engine 242 may discard all match results for the rule type and execute the next rule type. In an implementation, the rule that resulted in the ambiguity may be recorded by rules engine 242. In examples, if a single match result is obtained for a given rule type, then rules engine 242 may compare the match result against single match results obtained for other rule types. If all match results for different rule types belong to the same user, rules engine 242 may map the security event to the user.

According to an implementation, association system 204 may monitor the overall rate of ambiguous rule executions and establish a baseline organization ambiguity score. In examples, when rules that are recommended for removal by association system 204 are removed, association system 204 may reassess the organization ambiguity score. In examples, a decrease in the ambiguity score may be evaluated in relation to the removed rules to determine whether the recommendation of association system 204 is effective.

In an example, association system 204 may provide a list of recommended rules for removal to the system administrator of the organization. For example, based on one of the previously described counters or ambiguity scores, association system 204 may recommend one or more rules for removal to the system administrator. In examples, association system 204 may perform a test evaluation by executing the combined rule list on one or more security events stored in common information store 256, without one or more of the recommended one or more rules for removal to determine test counts or scores which are representative of a decrease or increase in ambiguity of security event mapping. In an implementation, association system 204 may use the test counts or scores to alter the recommended rules for removal, where the rules that provide the greatest decrease may be given a higher recommendation than rules that provide a lesser decrease. In an example, association system 204 may remove from the list of recommended rules for removal, one or more rules for which the text counts or scores illustrate an increase in ambiguity of security event mapping. In examples, the security events in common information store 256 used for the test evaluation may be filtered based on aging, i.e., the combined rule list may be executed on security events from the last T hours or days, where T may be set by the system administrator. In examples, the combined rule list not comprising or without having recommended rules for removal (i.e., the updated combines rule list) may be executed against security events stored in unmapped security event store 260. In examples, the effectiveness of the updated combined rule list may be used to advise the recommendations provided to the system administrator.

According to aspects of the present disclosure, association system 204 may use artificial intelligence (AI) models for recommending rules to the system administrator. In examples, AI models may include linear regression models, logistic regression models, linear discriminant analysis models, decision tree models, naïve bayes models, K-nearest neighbors models, learning vector quantization models, support vector machines, bagging and random forest models, and deep neural networks. In an implementation, an AI model may aim to learn a function which provides the most precise correlation between input values (X) and output values (Y):

$$Y = f ( X ) \qquad ( 1 )$$

In an implementation, the AI model may be trained using historic sets of inputs (X) and outputs (Y) that are known to be correlated. For example, a linear regression AI model may be represented by the expression:

$$Y = {B}_{0} \times {B}_{1} X \qquad ( 2 )$$

In examples, a set of n historical data points (Xi, Yᵢ) may be used to estimate the values for B₀ and B₁, for example:

$${B}_{1} = \frac{{\sum }_{i = 1}^{n} ( ( {X}_{i} - {\overline{X}}_{i} ) \times ( {Y}_{i} - {\overline{Y}}_{i} ) )}{{\sum }_{i = 1}^{n} {( {X}_{i} - {\overline{X}}_{i} )}^{2}} \qquad ( 3 )$$

$${B}_{0} = \overline{{Y}_{ι}} - {B}_{1} ( {\overline{X}}_{i} ) \qquad ( 4 )$$

In examples, parameters B₀ and B₁ may be considered coefficients of the linear regression AI model. The linear regression AI model with these initial coefficients may then be used to predict the output of the linear regression AI model for Y_{i,M}, given the set of historic inputs Xi. Thus, Y_{i,M}, corresponds to a derived output of the linear regression AI model given Xi, and may differ to a known (or “correct”) output for input Xi. The error of these predictions may be calculated using Root Mean Square Error (RMSE), for example:

$$R M S E = \sqrt{{\sum }_{i = 1}^{n} \frac{{( {Y}_{i , M} - {Y}_{i} )}^{2}}{n}} \qquad ( 5 )$$

In examples, training the linear regression AI model requires adjusting the coefficients B₀ and B₁ to minimize the RMSE over multiple historical data sets (Xii, Yᵢ). Different types of AI models use different techniques to adjust the weights (or values) of various coefficients, in general by using historical data sets that are correlated in the way that the AI models attempt to predict in new data sets by minimizing the predicted error of the AI model when applied to the historical data sets.

In examples, an AI model may be trained using the data set of user records, where the inputs to the AI model may be the combined rule list and the output of the AI model may be the overall rate of ambiguous rule executions. As rules are recommended for removal or deletion, the AI model may estimate the likely change in the overall rate of ambiguous rule executions if one or more of the recommended rules are removed from the combined rule set. In examples, the output of the AI model may be a recommended combined rule set (or updated combined rule set) for the organization.

In an implementation, a combined rule list may be executed against security event identifiers of security events in stored in unmapped security event store 260. In examples, the combined rule list may be updated to exclude the rule identified as ambiguous. In some implementations, execution of the combined rule list may be triggered against security event identifiers of security events stored in unmapped security event store 260 responsive to one of new user metadata or new user records in user metadata store 246.

According to an example, association system 204 or the system administrator may trigger the execution of the updated combined rule list against security events in unmapped security event store 260. In examples, only unmapped security events that have been received within a recent period of time may be evaluated (for example to eliminate security events that may be stale). In an implementation, the updated combined rule list may be executed against unmapped security events of a certain type or associated with a particular security event identifier. In examples, the reevaluation of unmapped security events using the updated combined rule list may be triggered by the addition of new metadata or by the addition of new user records in user metadata store 246. In examples, the evaluations may be performed using an AI model.

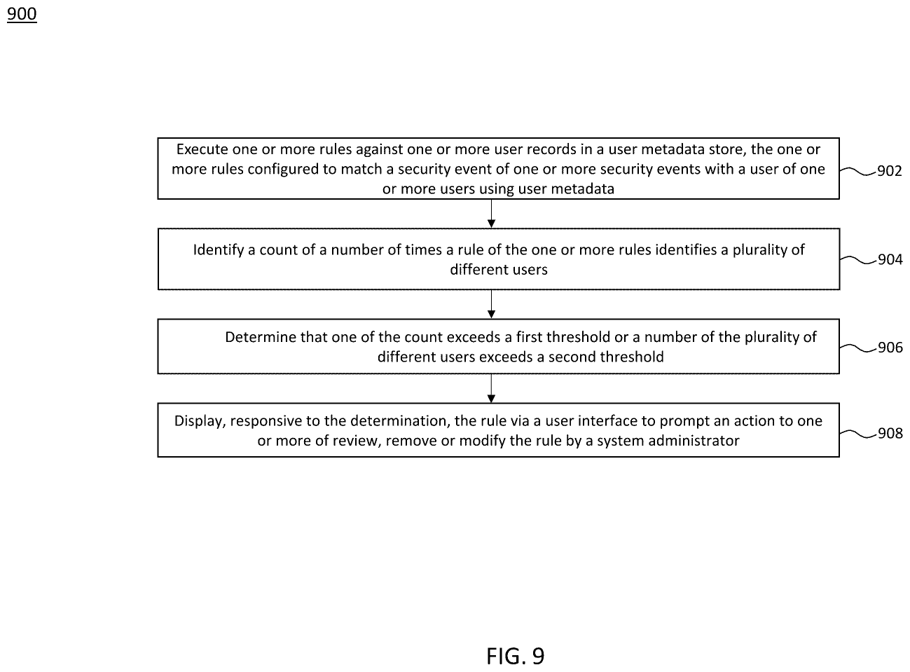

FIG. 9 depicts flowchart 900 for security event association rule refresh, according to some embodiments.

In a brief overview of an implementation of flowchart 900, at step 902, one or more rules may be executed against one or more user records in user metadata store 246. In examples, the one or more rules may be configured to match a security event of one or more security events with a user of one or more users using user metadata. At step 904, a count of a number of times a rule of the one or more rules identifies a plurality of different users may be identified. At step 906, it may be determined that one of the count exceeds a first threshold or a number of the plurality of different users exceeds a second threshold. At step 908, responsive to the determination, the rule may be displaced via a user interface (for example, administrator interface 282) to prompt an action to one or more of review, remove or modify the rule by a system administrator.

Step 902 includes executing one or more rules against one or more user records in user metadata store 246. In examples, the one or more rules may be configured to match a security event of one or more security events with a user of one or more users using user metadata. According to an implementation, rules refresh engine 244 may be configured to execute the one or more rules against the one or more user records in user metadata store 246. In examples, rules refresh engine 244 may execute one or more rules of a same type from a combined rule list. According to some implementations, rules refresh engine 244 may determine that a plurality of rules results in an ambiguity of matching a user to the security event.

Step 904 includes identifying a count of a number of times a rule of the one or more rules identifies a plurality of different users. According to an implementation, rules refresh engine 244 may be configured to identify the count of the number of times the rule of the one or more rules identifies the plurality of different users. In examples, the rule may have a left-hand-side (LHS) of the rule that includes a security event identifier of one of the one or more security events and a right-hand-side (RHS) of the rule that includes the user metadata. In some implementations, rules refresh engine 244 may be configured to determine an ambiguity score for the rule of the one or more rules. In examples, the ambiguity score may be based at least on the count.

Step 906 includes determining that one of the count exceeds a first threshold or a number of the plurality of different users exceeds a second threshold. According to an implementation, rules refresh engine 244 may be configured to determine that one of the count exceeds the first threshold or a number of the plurality of different users exceeds the second threshold.

Step 908 includes displaying, responsive to the determination, the rule via a user interface to prompt an action to one or more of review, remove or modify the rule by a system administrator. According to an implementation, rules refresh engine 244 may be configured to display, responsive to the determination, the rule via the user interface (for example, administrator interface 282) to prompt the action to one or more of review, remove or modify the rule by the system administrator. In an implementation, rules refresh engine 244 may display the ambiguity score with the rule. According to some implementations, rules refresh engine 244 may determine a ranked list of the one or more rules to one or more of review, remove or modify. In some implementations, rules refresh engine 244 may display the ranked list of the one or more rules to prompt the action to review, remove or modify by the system administrator. According to some implementations, rules refresh engine 244 may execute a combined rule list against security event identifiers of security events in unmapped security event store 260. In examples, the combined rule list may be updated to exclude the rule identified as ambiguous. According to some implementations, rules refresh engine 244 may trigger execution of the combined rule list against security event identifiers of security events in unmapped security event store 260 responsive to one of new user metadata or new user records in user metadata store 246.

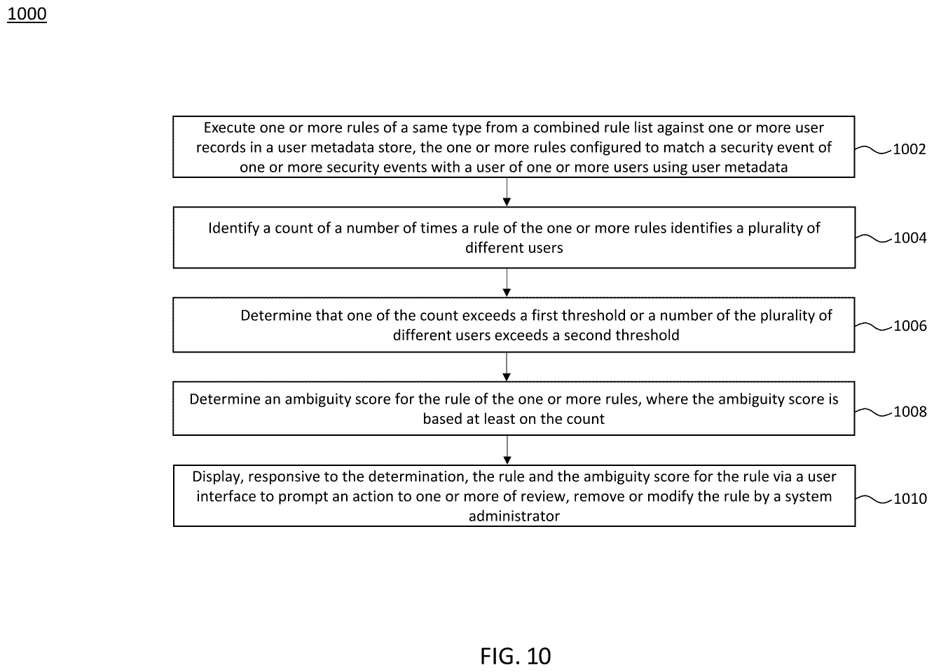

FIG. 10 depicts another flowchart 1000 for security event association rule refresh, according to some embodiments.

In a brief overview of an implementation of flowchart 1000, at step 1002, one or more rules of a same type from a combined rule list may be executed against one or more user records in user metadata store 246. In examples, the one or more rules may be configured to match a security event of one or more security events with a user of one or more users using user metadata. At step 1004, a count of a number of times a rule of the one or more rules identifies a plurality of different users may be identified. At step 1006, it may be determined that one of the count exceeds a first threshold or a number of the plurality of different users exceeds a second threshold. At step 1008, an ambiguity score for the rule of the one or more rules may be determined. In examples, the ambiguity score may be based at least on the count. At step 1010, responsive to the determination, the rule and the ambiguity score may be displaced via a user interface (for example, administrator interface 282) to prompt an action to one or more of review, remove or modify the rule by a system administrator.

Step 1002 includes executing one or more rules of a same type from a combined rule list against one or more user records in user metadata store 246. In examples, the one or more rules may be configured to match a security event of one or more security events with a user of one or more users using user metadata. According to an implementation, rules refresh engine 244 may be configured to execute the one or more rules of the same type from the combined rule list against the one or more user records in user metadata store 246. According to some implementations, rules refresh engine 244 may determine that a plurality of rules results in an ambiguity of matching a user to the security event.

Step 1004 includes identifying a count of a number of times a rule of the one or more rules identifies a plurality of different users. According to an implementation, rules refresh engine 244 may be configured to identify the count of the number of times the rule of the one or more rules identifies the plurality of different users. In examples, the rule may have a left-hand-side (LHS) of the rule that includes a security event identifier of one of the one or more security events and a right-hand-side (RHS) of the rule that includes the user metadata.

Step 1006 includes determining that one of the count exceeds a first threshold or a number of the plurality of different users exceeds a second threshold. According to an implementation, rules refresh engine 244 may be configured to determine that one of the count exceeds the first threshold or a number of the plurality of different users exceeds the second threshold.

Step 1008 includes determining an ambiguity score for the rule of the one or more rules. In examples, the ambiguity score may be based at least on the count. According to an implementation, rules refresh engine 244 may be configured to determine the ambiguity score for the rule of the one or more rules.

Step 1010 includes displaying, responsive to the determination, the rule and the ambiguity score for the rule via a user interface to prompt an action to one or more of review, remove or modify the rule by a system administrator. According to an implementation, rules refresh engine 244 may be configured to display, responsive to the determination, the rule and the ambiguity score for the rule via the user interface (for example, administrator interface 282) to prompt the action to one or more of review, remove or modify the rule by the system administrator. According to some implementations, rules refresh engine 244 may determine a ranked list of the one or more rules to one or more of review, remove or modify. In some implementations, rules refresh engine 244 may display the ranked list of the one or more rules to prompt the action to review, remove or modify by the system administrator. According to some implementations, rules refresh engine 244 may execute a combined rule list against security event identifiers of security events in unmapped security event store 260. In examples, the combined rule list may be updated to exclude the rule identified as ambiguous. According to some implementations, rules refresh engine 244 may trigger execution of the combined rule list against security event identifiers of security events in unmapped security event store 260 responsive to one of new user metadata or new user records in user metadata store 246.

The systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMS, RAMS, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method comprising:
executing, by one or more processors, one or more rules against one or more user records in a user metadata store, the one or more rules configured to match a security event of one or more security events with a user of one or more users using user metadata;
identifying, by the one or more processors, a count of a number of times a rule of the one or more rules identifies a plurality of different users;
determining, by the one or more processors, that one of the count exceeds a first threshold or a number of the plurality of different users exceeds a second threshold; and
displaying, by the one or more processors responsive to the determination, the rule via a user interface to prompt an action to one or more of review, remove or modify the rule by a system administrator.

2. The method of claim 1, wherein the rule has a left-hand-side of the rule that comprises a security event identifier of one of the one or more security events and a right-hand-side of the rule that comprises the user metadata.

3. The method of claim 1, further comprising determining, by the one or more processors, an ambiguity score for the rule of the one or more rules.

4. The method of claim 3, wherein the ambiguity score is based at least on the count.

5. The method of claim 3, further comprising displaying, by the one or more processors, the ambiguity score with the rule.

6. The method of claim 1, further comprising determining, by the one or more processors, that a plurality of rules results in an ambiguity of matching a user to the security event.

7. The method of claim 1, further comprising executing, by the one or more processors, one or more rules of a same type from a combined rule list.

8. The method of claim 1, further comprising determining, by the one or more processors, a ranked list of the one or more rules to one or more of review, remove or modify and displaying, by the one or more processors, the ranked list of the one or more rules to prompt the action to review, remove or modify by the system administrator.

9. The method of claim 1, further comprising executing, by the one or more processors, a combined rule list against security event identifiers of security events in an unmapped security event store, the combined rule list updated to exclude the rule identified by the one or more processors.

10. The method of claim 1, further comprising triggering, by the one or more processors, execution of the combined rule list against security event identifiers of security events in an unmapped security event store responsive to one of new user metadata or new user records in the user metadata store.

11. A system comprising:
one or more processors, coupled to memory and configured to:
execute one or more rules against one or more user records in a user metadata store, the one or more rules configured to match a security event of one or more security events with a user of one or more users using user metadata;
identify a count of a number of times a rule of the one or more rules identifies a plurality of different users;
determine that one of the count exceeds a first threshold or a number of the plurality of different users exceeds a second threshold; and
display, responsive to the determination, the rule via a user interface to prompt an action to one or more of review, remove or modify the rule by a system administrator.

12. The system of claim 11, wherein the rule has a left-hand-side of the rule that comprises a security event identifier of one of the one or more security events and a right-hand-side of the rule that comprises the user metadata.

13. The system of claim 11, wherein the one or more processors are further configured to determine an ambiguity score for the rule of the one or more rules.

14. The system of claim 13, wherein the ambiguity score is based at least on the count.

15. The system of claim 13, wherein the one or more processors are further configured to display the ambiguity score with the rule.

16. The system of claim 11, wherein the one or more processors are further configured to determine that a plurality of rules results in an ambiguity of matching a user to the security event.

17. The system of claim 11, wherein the one or more processors are further configured to execute one or more rules of a same type from a combined rule list.

18. The system of claim 11, wherein the one or more processors are further configured to determine a ranked list of the one or more rules to one or more of review, remove or modify and displaying, by the one or more processors, the ranked list of the one or more rules to prompt the action to review, remove or modify by the system administrator.

19. The system of claim 11, wherein the one or more processors are further configured to execute a combined rule list against security event identifiers of security events in an unmapped security event store, the combined rule list updated to exclude the rule identified by the one or more processors.

20. The system of claim 11, wherein the one or more processors are further configured to trigger execution of the combined rule list against security event identifiers of security events in an unmapped security event store responsive to one of new user metadata or new user records in the user metadata store.
